(19) United States
(12) Patent Application Publication
(10) Pub. No.: US 2019/0211139 A1
(43) Pub. Date: Jul. 11, 2019

(54) BIORENEWABLE EPOXY RESINS DERIVED FROM PHENOLIC ACIDS

(71) Applicant: UNIVERSITY OF HOUSTON SYSTEM, Houston, TX (US)

(72) Inventors: Megan ROBERTSON, Houston, TX (US); Guozhen YANG, Houston, TX (US); Brian ROHDE, Houston, TX (US)

(73) Assignee: UNIVERSITY OF HOUSTON SYSTEM, Houston, TX (US)

(21) Appl. No.: 16/325,694

(22) PCT Filed: Aug. 14, 2017
(86) PCT No.: PCT/US17/46789

§ 371 Date: Feb. 14, 2019

Related U.S. Application Data
(60) Provisional application No. 62/375,233, filed on Aug. 15, 2016.

(51) Int. Cl. C08G 59/24; C08G 59/42; C08G 59/50

(52) U.S. Cl. CPC C08G 59/245; C08G 59/4238; C08G 59/5026; C08G 59/5033; C08G 59/502

(57) ABSTRACT

In some aspects, the present disclosure provides epoxy resins from an epoxide containing aromatic compound. The epoxy resin may further comprise one or more curing agents which change the properties of the epoxy resin. Also described herein are methods of preparing epoxy resins using the epoxide containing aromatic compounds and materials prepared with them.

This application claims benefit of priority to U.S. Provisional Application Ser. No. 62/375,233, filed Aug. 15, 2016, the entire contents of which are hereby incorporated by reference.

The invention was made with government support under Grant No. CMMI-1334838 and DMR-1611376 awarded by the National Science Foundation. The government has certain rights in the invention.

### BACKGROUND

### 1. Field

The present disclosure relates generally to the field of materials and material science. In some embodiments, the present disclosure relates to epoxy resins with renewable feedstocks.

### 2. Description of Related Art

Epoxy resins are widely applied in composite, coating, adhesive, automotive, and other applications, due to their superior chemical, electrical and heat resistance, adhesion, and mechanical properties (Pham et al., 2002). Additionally, epoxy resins play an important role in wind power, a renewable energy source and attractive alternative to fossil fuel (Haymana et al., 2008). Traditional epoxy resins are derived from petroleum, which produces harmful environmental impacts when processed. Additionally, there are potential health impacts from residual monomers and additives in polymers and traditional epoxy resins are derived from bisphenol A, a chemical that has received much attention due to negative health consequences (Vanderberg et al, 2009). Thus, developing new epoxy resins which do not require petroleum or petroleum byproducts are of considerable interest.

Prior studies have investigated sustainable replacements for traditional epoxy resins components. The incorporation of vegetable oils into epoxy resins has been a recent focus in the literature (Czub, 2006; Frischinger and Dirlikov, 1991; Jin and Park, 2008a; Jin and Park, 2008b; Miyagawa et al., 2005; Park et al., 2004a; Park et al., 2004b; Frischinger and Dirlikov, 1993; Raquez et al., 2010; Tan and Chow, 2011; Mustata et al., 2011; Gupta et al., 2011; Espinoza-Perez et al., 2011; Cheng et al., 2011; Altuna et al., 2011; Tan and Chow, 2010; Czub, 2009; Supanchaiyamat et al., 2012; Sarwono et al., 2012; Samper et al., 2012; Espana et al., 2012; Liu et al., 2004; El Gouri et al., 2009; Yang et al., 2013). The vegetable oil-containing epoxy resins exhibit a higher fracture toughness and impact strength, with a corresponding decrease in the glass transition temperature, due to a decrease in the crosslink density and increase in chain flexibility (Czub, 2006; Frischinger and Dirlikov, 1991; Jin and Park, 2008a; Jin and Park, 2008b; Miyagawa et al., 2005; Park et al., 2004a; Park et al., 2004b; Frischinger and Dirlikov, 1993; Raquez et al., 2010; Gupta et al., 2011; Cheng et al., 2011; Altuna et al., 2011).

Other raw material sources have also been considered for the development of epoxy resins. Isosorbide, a glucose-derived molecule, has attracted recent attention due to its rigid structure and the presence of hydroxyl groups which are amendable to conversion to the epoxide groups required for the epoxy resin synthesis. Though isosorbide-based epoxy resins have desirable attributes (Busto et al., 2011; Chrysanthos et al., 2011; Feng et al., 2012; Feng et al., 2011; Lukaszczyk et al., 2011; Nelson and Long, 2012), they also exhibit significant water-uptake relative to conventional epoxy resins (Busto et al., 2011; Feng et al., 2012).

Furans (also derived from plant sugars and polysaccharides) can be functionalized with carboxylic acids which can be converted to epoxides or amines (such as 2,5-furan-dicarboxyl acid) (van Beilen and Poirer, 2008). Additionally, rosins, obtained from sources such as pines and other conifers (Liu et al., 2012), lignin (Simionescu et al., 1993; Sun et al., 2007), cellulose (Varma and Chavan, 1994), and other plant-sourced molecules can be used to synthesize epoxy resin components, though the resulting resins do not exhibit all of the physical properties required of this class of material to compete with traditional epoxy resins, and in some cases complex and multi-step syntheses are required to produce the resin precursors. As such, there still remain a significant need to develop new materials as epoxy resins.

### SUMMARY

In some aspects, the present disclosure provides methods of preparing epoxy resins from renewable sources. In some embodiments, the present disclosure provides resins comprising:
(A) a naturally occurring aromatic compound wherein the aromatic compound has been modified to contain at least one epoxidized hydroxy group and at least one epoxidized carboxylic acid group; and
(B) a curing agent selected from an anhydride, an acid, an alcohol, a thiol, a phenol, or an amine;
   provided that the aromatic compound is not an epoxidized version of gallic acid.

In some embodiments, the aromatic compound contains one epoxidized hydroxy group. Additionally, the aromatic compound may contain one epoxidized carboxylic acid group. In some embodiments, the aromatic compound contains one epoxidized hydroxy group and one epoxidized carboxylic acid group. The aromatic compound may be further defined as:

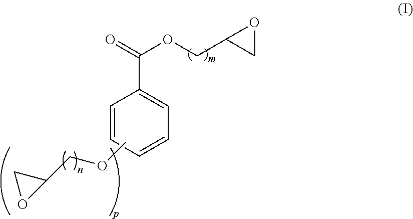

wherein:
n and m are each independently 0, 1, 2, 3, or 4; and
p is 1, 2, or 3.
   In some embodiments, the aromatic compound is further defined as:

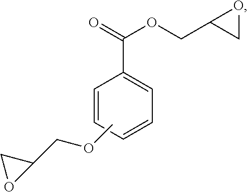

such as

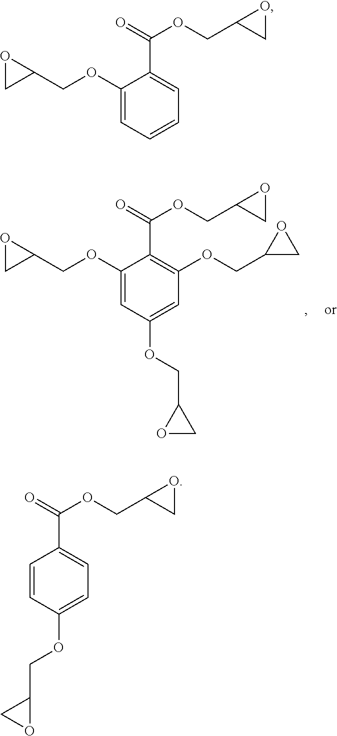 [SMILES: O=C(OCC1CO1)c1ccccc1OCC1CO1 ; O=C(OCC1CO1)c1c(OCC2CO2)cc(OCC2CO2)cc1OCC1CO1 ; O=C(OCC1CO1)c1ccc(OCC2CO2)cc1]

In some embodiments, the curing agent is an anhydride such as a cyclic anhydride. The curing agent may be:

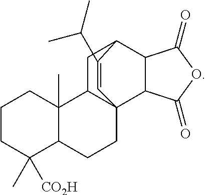 [SMILES: CC(C)C1=CC23CCC4C(C)(C(=O)O)CCCC4(C)C2CC1C1C(=O)OC(=O)C13]

Alternatively, the curing agent may be an anhydride containing one or more fused cycloalkyl groups comprising 6 carbon atoms to 18 carbon atoms. The anhydride may be a compound of the formula:

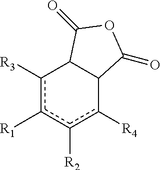

wherein:
R₁, R₂, R₃, and R₄ are each independently hydrogen, alkyl_{(C≤8)}, or substituted alkyl_{(C≤8)}, or R₁ and R₂, R₁, and R₃, R₁ and R₄, R₂ and R₃, R₂ and R₄, and R₃ and R₄ are taken together and are alkanediyl_{(C≤8)} or substituted alkanediyl_{(C≤8)}.
   In some embodiments, the anhydride is a compound of the formula:

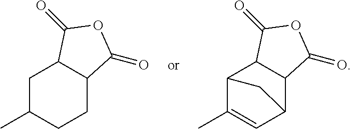

In other embodiments, the curing agent is an amine The amine may be a diamine such as an amine further defined as:

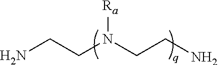

wherein:
Rₐ is hydrogen, alkyl_{(C≤6)}, or substituted alkyl_{(C≤6)}; and
q is 0, 1, 2, or 3.
   The amine may be further defined as:

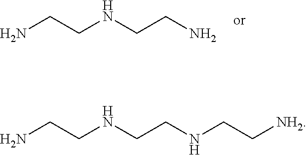 [SMILES: NCCNCCN ; NCCNCCNCCN]

In still other embodiments, the amine is further defined as:

H₂N—X₁—NH₂

wherein:
X₁ is alkanediyl_{(C≤12)}, cycloalkanediyl_{(C≤12)}, arenediyl_{(C≤12)}, aralkanediyl_{(C≤12)}, or a substituted version of any of these groups.
   The amine may be further defined as:

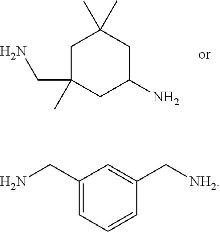

In some embodiments, the resins have a glass transition temperature from about 75° C. to about 200° C. The glass transition temperature may be from about 80° C. to about 110° C. or from about 100° C. to about 150° C. In some embodiments, the resins have a tensile strength of greater than 50 MPa. The tensile strength may be greater than 75 MPa. In some embodiments, the resins have a modulus of greater than 1.0 GPa. The modulus may be greater than 2.5 GPa. In some embodiments, the resins have an increased nucleation center density relative to DGEBA. The nucleation center density may be greater than 25 mm⁻². In some embodiments, the nucleation center density is greater than 100 mm⁻².

In yet another aspect, the present disclosure provides methods of preparing a resin comprising:
(A) admixing a naturally occurring aromatic compound with a curing agent in the presence of a catalyst and heating to a first temperature for a first time period to form a first reaction mixture; and
(B) heating the first reaction mixture to a second temperature for a second time period to obtain a resin;
   provided that the aromatic compound is not an epoxidized gallic acid.

In some embodiments, the aromatic compound contains one epoxidized hydroxy group. Additionally, the aromatic compound may contain one epoxidized carboxylic acid group. In some embodiments, the aromatic compound contains one epoxidized hydroxy group and one epoxidized carboxylic acid group. The aromatic compound may be further defined as:

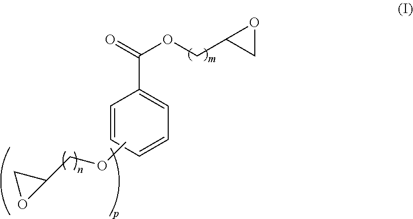

wherein:
n and m are each independently 0, 1, 2, 3, or 4; and
p is 1, 2, or 3.
   In some embodiments, the aromatic compound is further defined as:

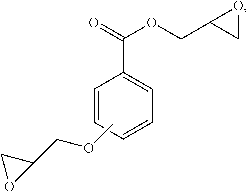

such as

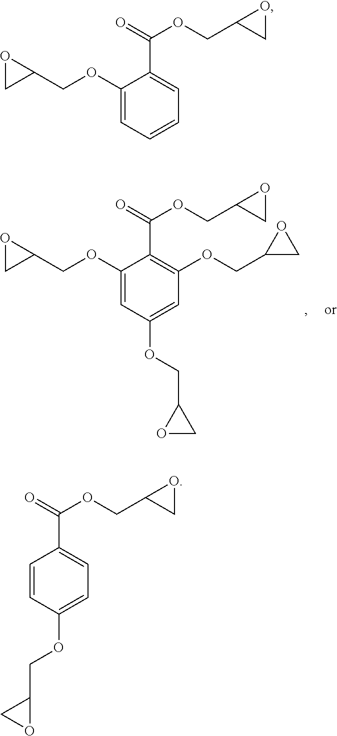 [SMILES: O=C(OCC1CO1)c1ccccc1OCC1CO1 ; O=C(OCC1CO1)c1c(OCC2CO2)cc(OCC2CO2)cc1OCC1CO1 ; O=C(OCC1CO1)c1ccc(OCC2CO2)cc1]

In some embodiments, the curing agent is an anhydride, an acid, an alcohol, a thiol, a phenol, or an amine In some embodiments, the curing agent is an anhydride such as a cyclic anhydride. The curing agent may be:

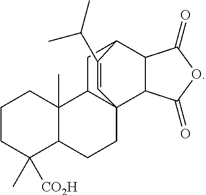 [SMILES: CC(C)C1=CC23CCC4C(C)(C(=O)O)CCCC4(C)C2CC1C1C(=O)OC(=O)C13]

Alternatively, the curing agent may be an anhydride containing one or more fused cycloalkyl groups comprising 6 carbon atoms to 18 carbon atoms. The anhydride may be a compound of the formula:

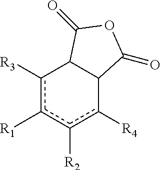

wherein:
R₁, R₂, R₃, and R₄ are each independently hydrogen, alkyl_{(C≤8)}, or substituted alkyl_{(C≤8)}, or R₁ and R₂, R₁, and R₃, R₁ and R₄, R₂ and R₃, R₂ and R₄, and R₃ and R₄ are taken together and are alkanediyl_{(C≤8)} or substituted alkanediyl_{(C≤8)}.
   In some embodiments, the anhydride is a compound of the formula:

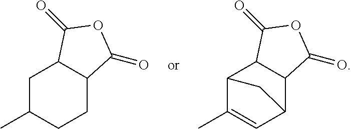

In other embodiments, the curing agent is an amine The amine may be a diamine such as an amine further defined as:

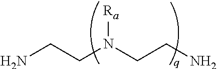

wherein:
Rₐ is hydrogen, alkyl_{(C≤6)}, or substituted alkyl_{(C≤6)}; and
q is 0, 1, 2, or 3.
   The amine may be further defined as:

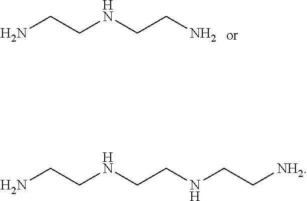 [SMILES: NCCNCCN ; NCCNCCNCCN]

In still other embodiments, the amine is further defined as:

H₂N—X₁—NH₂

wherein:
X₁ is alkanediyl_{(C≤12)}, cycloalkanediyl_{(C≤12)}, arenediyl_{(C≤12)}, aralkanediyl_{(C≤12)}, or a substituted version of any of these groups.
   The amine may be further defined as:

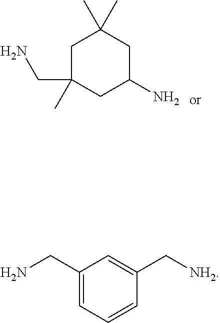

In some embodiments, the catalyst is a Lewis base. The catalyst may be a tertiary amine such as Ancamine® K54 or a compound of the formula:

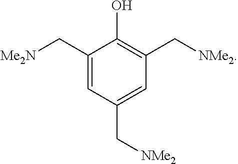 [SMILES: CN(C)Cc1cc(CN(C)C)c(O)c(CN(C)C)c1]

In other embodiments, the catalyst is a base such as an imidazole. The catalyst may be 1-methylimidazole.

In some embodiments, the first temperature is from about 50° C. to about 300° C. The first temperature may be from about 60° C. to about 100° C. such as about 70° C. In some embodiments, the first time period is from about 10 minutes to about 12 hours. The first time period may be from about 1 hour to about 4 hours such as about 2 hours.

In some embodiments, the second temperature is from about 50° C. to about 300° C. The second temperature is from about 150° C. to about 200° C. such as about 170° C. In some embodiments, the second time period is from about 10 minutes to about 12 hours. The second time period may be from about 1 hour to about 4 hours such as about 2 hours.

In some embodiments, the mole ratio of the curing agent to the aromatic compound is from about 0.5 to about 5. The mole ratio may be from about 1.0 to about 2.5 such as about 2. In some embodiments, the mole ratio of the curing agent is equal to the number of epoxide groups on the aromatic compound. In some embodiments, the amount of catalyst present in the method is from about 100 parts per thousand relative to the resin to about 100 parts per hundred. The amount of catalyst may be from about 1 part per thousand to about 10 parts per hundred such as about 3 parts per hundred.

In some embodiments, the methods produce a resin with a glass transition temperature from about 75° C. to about 200° C. The glass transition temperature may be from about 80° C. to about 110° C. or from about 100° C. to about 150° C. In some embodiments, the methods produce a resin with a tensile strength of greater than 50 MPa. The tensile strength may be greater than 75 MPa. In some embodiments, the methods produce a resin with a modulus of greater than 1.0 GPa. The modulus may be greater than 2.5 GPa. In some embodiments, the methods produce a resin had an increased nucleation center density relative to DGEBA. The nucleation center density may be greater than 25 mm⁻² or greater than 100 mm⁻².

In still yet another aspect, the present disclosure provides an article of manufacture prepared using the resin described herein or prepared according to the methods herein. The article may coated with the resin. Alternatively, the article may comprises a body prepared using the resin. Additionally, the article may comprises a core prepared using the resin.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-B show proton nuclear magnetic resonance (¹H NMR) data obtained from epoxidized salicylic acid (ESA) (FIG. 1A) and epoxidized 4-hydroxybenzoic acid (E4HBA) (FIG. 1B).

FIGS. 2A-B show a closer view of ¹H NMR data obtained from ESA (FIG. 2A). Carbon (¹³C) NMR data obtained from ESA is shown in (FIG. 2B).

FIGS. 3A-B show a closer view of ¹H NMR data obtained from E4HBA (FIG. 3A). ¹³C NMR data obtained from E4HBA is shown in (FIG. 3B).

FIGS. 4A-B show in (FIG. 4A) Heat flow as a function of temperature (obtained from differential scanning calorimetry, DSC) for ESA cured with different curing agents: meta-xylenediamine (MXDA, curve 1), triethylenetetramine (TETA, curve 2), diethylenetriamine (DETA, curve 3), isophorodiamine (IPDA, curve 4), methylhexahydrophthalic anhydride (MHHPA, +3 phr 1-methyl-imidazole [1-MI], curve 5), nadic methyl anhydride (NMA, +3 phr Ancamine K54, curve 6). (FIG. 4B) shows heat flow as a function of temperature (obtained from DSC) for epoxy resins produced by curing the following epoxy monomers with MHHPA (+3 phr 1-MI): diglycidyl ether of bisphenol A (DGEBA), ESA, and E4HBA.

FIGS. 5A-B shows in (FIG. 5A) Weight % as a function of temperature (obtained from thermogravimetric analysis, TGA) for epoxy resins containing ESA (solid curve) and E4HBA (dashed curve). The temperature was heated from 25 to 550° C. at a rate of 10° C./min (FIG. 5B) Glass transition temperature (T_{g}) as a function of post-curing time at 170° C. (following pre-curing for 2 h at 70° C.) for epoxy resins derived from ESA (●), E4HBA (▴) and DGEBA (□). All epoxy resins were cured with MHHPA (+3 phr 1-MI). Error bars indicate repeat measurements on multiple specimens.

FIGS. 6A-C shows Fourier transform infrared spectroscopy (FTIR) data (transmission mode) obtained from a mixture of anhydride, 1-MI (3 phr), and (FIG. 6A) ESA, (FIG. 6B) E4HBA and (FIG. 6C) DGEBA. The anhydride C═O peaks at 1788 and 1857 cm-1 and anhydride show decreases in intensity as the sample is cured for 1 and 2 h at 70° C. These peaks disappear upon post-curing at 170° C. (dashed curves). The ester C═O peak increases upon curing for 1 and 2 h at 70° C., and further increases following post-curing at 170° C. (dashed curve). The epoxy monomer and curing agent were used at the stoichiometric ratio.

FIG. 7 shows a stress-strain curves obtained from five independent specimens of ESA-based epoxy resins.

FIG. 8 shows a stress-strain curves obtained from five independent specimens of E4HBA-based epoxy resins.

FIGS. 9A-C shows a stress-strain curves obtained from three batches with five independent specimens for each of DGEBA-based epoxy resins.

FIGS. 10A-C shows a scanning electron microscopy (SEM) micrographs of tensile test specimen fracture surfaces of epoxy resins derived from ESA (FIG. 10A), E4HBA (FIG. 10B), and DGEBA (FIG. 10C). The arrows in the micrographs indicate the crack propagation direction.

FIGS. 11A-D shows a SEM micrographs of the fracture surface of ESA epoxy resins after tensile test: (FIG. 11A) the fracture surface (×200), (FIG. 11B) the crack initiation site (×400), (FIG. 11C-D) crack propragation (×400).

FIGS. 12A-D shows a SEM micrographs of the fracture surface of E4HBA epoxy resins after tensile test: (FIG. 12A) the fracture surface (×200), (FIG. 12B) the crack initiation site (×400), (FIG. 12C-D) crack propregation (×400).

FIGS. 13A-D shows a SEM micrographs of the fracture surface of DGEBA epoxy resins after tensile test: (FIG. 13A) the fracture surface (×200), (FIG. 13B) the crack initiation site (×400), (FIG. 13C-D) crack propregation (×400).

FIGS. 14A-F shows a SEM micrographs of the fracture surface (grey level) of ESA epoxy resins after tensile test with the feature identification (dark lines).

FIGS. 15A-F shows a SEM micrographs of the fracture surface (grey level) of E4HBA epoxy resins after tensile test with the feature identification (dark lines).

FIGS. 16A-F shows a SEM micrographs of the fracture surface (grey level) of DGEBA epoxy resins after tensile test with the feature identification (dark lines).

### DESCRIPTION OF ILLUSTRATIVE EMBODIMENTS

In some aspects, the present disclosure provides new epoxy resins prepared from renewable sources as well as methods to prepare these epoxy resins. In some embodiments, the renewable sources comprise an aromatic compound with one or more hydroxy groups and a carboxylic acid group which have been functionalized with an epoxide group. In some embodiments, the epoxy groups are cured with one or more different functional groups such as an amine, an aldehyde, an anhydride, or a phenol. In some aspects, the present disclosure provides materials prepared with an epoxy resin as described herein.

### I. Epoxy Resins

In some aspects, the present disclosure provides epoxy resins which are generated from starting materials which may be obtained without the use of petroleum based compounds. These starting materials may be a material obtain from a plant based source, an animal based source, or another natural source. In some embodiments, the starting material is an epoxide functionalized aromatic compound. The aromatic compound may contain one or more hydroxy groups which have been functionalized with an epoxide group and one or more carboxylic acid which has been functionalized with an epoxide group. In some embodiments, the starting material of the aromatic compound is not gallic acid. In some embodiments, the number of hydroxy groups is 1, 2, or 3. In other embodiments, the number of carboxylic acid groups is 1 or 2. The aromatic compound may be functionalized with one or more other groups such as a amino, aminosulfonyl, carboxy, cyano, halo, hydroxy, hydroxyamino, hydroxysulfonyl, mercapto, nitro, oxo, or thio; or acyl_{(C≤8)}, alkoxy_{(C≤8)}, cycloalkoxy_{(C≤8)}, alkenyloxy_{(C≤8)}, aryloxy_{(C≤8)}, aralkoxy_{(C≤8)}, acyloxy_{(C≤8)}, cycloalkylalkoxy_{(C≤8)}, heterocycloalkylalkoxy_{(C≤8)}, heterocycloalkoxy_{(C≤8)}, alkylthio_{(C≤8)}, cycloalkylthio_{(C≤8)}, amido_{(C≤8)}, alkylamino_{(C≤8)}, dialkylamino_{(C≤8)}, alkylsulfonyl_{(C≤8)}, arylsulfonyl_{(C≤8)}, or a substituted version of these groups, or a protected amine group, a protected hydroxyl group, or a protected thiol group. The aromatic compound may be functionalized with 1, 2, or 3 groups.

The compounds of the present disclosure are shown, for example, above, in the summary section, and in the claims below. They may be made using the synthetic methods outlined in the Examples section. These methods can be further modified and optimized using the principles and techniques of organic chemistry as applied by a person skilled in the art. Such principles and techniques are taught, for example, in Smith, March's Advanced Organic Chemistry: Reactions, Mechanisms, and Structure, (2013), which is incorporated by reference herein. In addition, the synthetic methods may be further modified and optimized for preparative, pilot- or large-scale production, either batch or continuous, using the principles and techniques of process chemistry as applied by a person skilled in the art. Such principles and techniques are taught, for example, in Anderson, Practical Process Research & Development—A Guide for Organic Chemists (2012), which is incorporated by reference herein.

In addition, atoms making up the compounds of the present disclosure are intended to include all isotopic forms of such atoms. Isotopes, as used herein, include those atoms having the same atomic number but different mass numbers. By way of general example and without limitation, isotopes of hydrogen include tritium and deuterium, isotopes of carbon include ¹³C and ¹⁴C, isotopes of oxygen include ¹⁷O and ¹⁸O, and isotopes of nitrogen include ¹⁵N.

In some embodiments, the epoxy resins prepared herein may have a tensile strength of greater than about 50 MPa, 55 MPa, 60 MPa, 65 MPa, 70 MPa, 75 MPa, 80 MPa, 81 MPa, 82 MPa, 83 MPa, 84 MPa, or 85 MPa. Furthermore, the resin may further comprise a modulus of greater than 1.0 GPa, 1.25 GPa, 1.5 GPa, 1.75 GPa, 2.0 GPa, 2.1 GPa, 2.2 GPa, 2.3 GPa, 2.4 GPa, 2.5 GPa, 2.6 GPa, 2.7 GPa, 2.8 GPa, or 2.9 GPa. These epoxy resins described herein may also have an increased nucleation center density relative to DGEBA. The nucleation center density is greater than 25 mm⁻², greater than 100 mm⁻², or greater than 200 mm⁻². The nucleation center density may be from 25, 50, 75, 100, 125, 150, 175, 200, 225, 250, 275, 300, 325, 350, 400, or 500 mm⁻², or any range derivable therein.

### II. Methods

In some aspects, the present disclosure provides methods of preparing epoxy resins including epoxy resins with curing agents. In some embodiments, the curing agent is an amine, a thiol, an anhydride, an alcohol, an acid, or a phenol. Some non-limiting examples of curing agents which may be used in the current methods include aliphatic amines [DETA (diethylenetriamine), TETA (triethylenetetramine), TMD (trimethyl hexamethylene diamine), polyetheramines, tetraethylenepentamine], cycloaliphatic amines [IPDA (isophorondiamine), MXDA (m-xylenediamine), aminothylpiperazine], amidoamines/polyamides [polyamidoimidazoline, polyamidoamine)], phenalkamines (including Mannich-based curing agents), aromatic amines [DDS (4,4′-diaminodiphenyl sulfone), 3,3′-diaminodiphenyl sulfone)], anhydrides [MHHPA (methylhexahydrophthalic anhydride), NMA (nadic methyl anhydride), methyl tetrahydrophthalic anhydride, hexahydrophthalic anhydride, methyl hexahydrophtalic anhydride], waterborne curing agents, and phenolic hardeners. In some embodiments, the curing agents act as cross-linkers which improve the properties of the resins including by cross linking the polymers.

In some embodiments, the epoxy resin is prepared by reacting the aromatic compound with a curing agent. The mole ratio of the curing agent to the aromatic compound may be from about 0.5 to about 5. In some embodiments, the mole ratio is from about 0.5 to about 4.0, from about 0.75 to about 3.0, or from about 1.0 to about 2.5. In some embodiments, the mole ratio is about 2.0. In other embodiments, the ratio of the aromatic compound to the curing agent is the number of epoxide groups on the aromatic compound.

Furthermore, the methods may further comprise adding a catalyst to the reaction mixture. In some embodiments, the catalyst is a base. The base may be a nitrogenous base such as Ancamine® K54 or 1-methylimidazole (1-MI). The catalyst also may be a tertiary amine, amine salt, boron trifluoride complex, and amine borate. The amount of catalyst added to the methods described herein may be from about 100 parts per thousand relative to the resin to about 100 parts per hundred of a catalyst. The amount of the catalyst used in the method is from about 500 parts per thousand to about 50 parts per hundred of the catalyst or from about 1 part per thousand to about 10 parts per hundred of the catalyst relative to the resin. The amount of resin used in the methods

In one aspect, the present methods involve heating the mixture to a first temperature from about 50° C. to about 300° C. The first temperature may be from about 50° C. to about 200° C., from about 60° C. to about 150° C., or from about 60° C. to about 100° C. The first temperature may be about 70° C. The methods may involve heating at this first temperature for a first time period from about 10 minutes to about 12 hours. In some embodiments, the first time period is from about 30 minutes to about 8 hours, from about 1 hour to about 6 hours, or from about 1 hour to about 4 hours. The first time period may be about 2 hours.

In another aspect, the present methods involve heating the mixture a second time to a second temperature from about 50° C. to about 300° C. The second temperature may be from about 100° C. to about 250° C., from about 125° C. to about 200° C., or from about 150° C. to about 200° C. The second temperature may be about 170° C. The methods may involve heating at this second temperature for a second time period from about 10 minutes to about 12 hours. In some embodiments, the second time period is from about 30 minutes to about 8 hours, from about 1 hour to about 6 hours, or from about 1 hour to about 4 hours. The second time period may be about 2 hours.

### III. Definitions

When used in the context of a chemical group: “hydrogen” means —H; “hydroxy” means —OH; “oxo” means ═O; “carbonyl” means —C(═O)—; “carboxy” means —C(═O)OH (also written as —COOH or —CO₂H); “halo” means independently —F, —Cl, —Br or —I; “amino” means —NH₂; “hydroxyamino” means —NHOH; “nitro” means —NO₂; imino means ═NH; “cyano” means —CN; “isocyanate” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” or “thiol” means —SH; and “thio” means ═S; “sulfonyl” means —S(O)₂—; “aminosulfonyl” means —S(O)₂NH₂; “hydroxysulfonyl” means —S(O)₂OH; and “sulfinyl” means —S(O)—.

In the context of chemical formulas, the symbol “—” means a single bond, “═” means a double bond, and “≡” means triple bond. The symbol “ [symbol] ” represents an optional bond, which if present is either single or double. The symbol “ [symbol] ” represents a single bond or a double bond. Thus, the formula

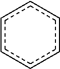

covers, for example,

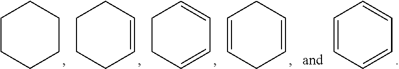

And it is understood that no one such ring atom forms part of more than one double bond. Furthermore, it is noted that the covalent bond symbol “—”, when connecting one or two stereogenic atoms, does not indicate any preferred stereochemistry. Instead, it covers all stereoisomers as well as mixtures thereof. The symbol “ [symbol] ”, when drawn perpendicularly across a bond (e.g.,

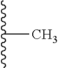

for methyl) indicates a point of attachment of the group. It is noted that the point of attachment is typically only identified in this manner for larger groups in order to assist the reader in unambiguously identifying a point of attachment. The symbol “ [symbol] ” means a single bond where the group attached to the thick end of the wedge is “out of the page.” The symbol “ [symbol] ” means a single bond where the group attached to the thick end of the wedge is “into the page”. The symbol “ [symbol] ” means a single bond where the geometry around a double bond (e.g., either E or Z) is undefined. Both options, as well as combinations thereof are therefore intended. Any undefined valency on an atom of a structure shown in this application implicitly represents a hydrogen atom bonded to that atom. A bold dot on a carbon atom indicates that the hydrogen attached to that carbon is oriented out of the plane of the paper.

When a group “R” is depicted as a “floating group” on a ring system, for example, in the formula:

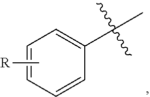

then R may replace any hydrogen atom attached to any of the ring atoms, including a depicted, implied, or expressly defined hydrogen, so long as a stable structure is formed. When a group “R” is depicted as a “floating group” on a fused ring system, as for example in the formula:

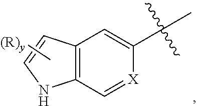

then R may replace any hydrogen attached to any of the ring atoms of either of the fused rings unless specified otherwise. Replaceable hydrogens include depicted hydrogens (e.g., the hydrogen attached to the nitrogen in the formula above), implied hydrogens (e.g., a hydrogen of the formula above that is not shown but understood to be present), expressly defined hydrogens, and optional hydrogens whose presence depends on the identity of a ring atom (e.g., a hydrogen attached to group X, when X equals —CH—), so long as a stable structure is formed. In the example depicted, R may reside on either the 5-membered or the 6-membered ring of the fused ring system. In the formula above, the subscript letter “y” immediately following the group “R” enclosed in parentheses, represents a numeric variable. Unless specified otherwise, this variable can be 0, 1, 2, or any integer greater than 2, only limited by the maximum number of replaceable hydrogen atoms of the ring or ring system.

For the chemical groups and compound classes, the number of carbon atoms in the group or class is as indicated as follows: “Cn” defines the exact number (n) of carbon atoms in the group/class. “C≤n” defines the maximum number (n) of carbon atoms that can be in the group/class, with the minimum number as small as possible for the group/class in question, e.g., it is understood that the minimum number of carbon atoms in the group “alkenyl_{(C≤8)}” or the class “alkene_{(C≤8)}” is two. Compare with “alkoxy_{(C≤10)}”, which designates alkoxy groups having from 1 to 10 carbon atoms. “Cn-n′” defines both the minimum (n) and maximum number (n′) of carbon atoms in the group. Thus, “alkyl_{(C2-10)}” designates those alkyl groups having from 2 to 10 carbon atoms. These carbon number indicators may precede or follow the chemical groups or class it modifies and it may or may not be enclosed in parenthesis, without signifying any change in meaning. Thus, the terms “C5 olefin”, “C5-olefin”, “olefin_{C5}”, and “olefin_{C5}” are all synonymous. When any of the chemical groups or compound classes defined herein is modified by the term “substituted”, any carbon atom(s) in a moiety replacing a hydrogen atom is not counted. Thus methoxyhexyl, which has a total of seven carbon atoms, is an example of a substituted alkyl_{(C1-6)}.

The term “saturated” when used to modify a compound or chemical group means the compound or chemical group has no carbon-carbon double and no carbon-carbon triple bonds, except as noted below. When the term is used to modify an atom, it means that the atom is not part of any double or triple bond. In the case of substituted versions of saturated groups, one or more carbon oxygen double bond or a carbon nitrogen double bond may be present. And when such a bond is present, then carbon-carbon double bonds that may occur as part of keto-enol tautomerism or imine/enamine tautomerism are not precluded. When the term “saturated” is used to modify a solution of a substance, it means that no more of that substance can dissolve in that solution.

The term “aliphatic” when used without the “substituted” modifier signifies that the compound or chemical group so modified is an acyclic or cyclic, but non-aromatic hydrocarbon compound or group. In aliphatic compounds/groups, the carbon atoms can be joined together in straight chains, branched chains, or non-aromatic rings (alicyclic). Aliphatic compounds/groups can be saturated, that is joined by single carbon-carbon bonds (alkanes/alkyl), or unsaturated, with one or more carbon-carbon double bonds (alkenes/alkenyl) or with one or more carbon-carbon triple bonds (alkynes/alkynyl).

The term “aromatic” when used to modify a compound or a chemical group refers to a planar unsaturated ring of atoms with 4n+2 electrons in a fully conjugated cyclic π system.

The term “alkyl” when used without the “substituted” modifier refers to a monovalent saturated aliphatic group with a carbon atom as the point of attachment, a linear or branched acyclic structure, and no atoms other than carbon and hydrogen. The groups —CH₃ (Me), CH—₂CH₃ (Et), —CH₂CH₂CH₃ (i-Pr, ⁱPr or propyl), —CH(CH₃)₂ (i-Pr, ⁱPr or isopropyl), —CH₂CH₂CH₂CH₃ (n-Bu), —CH(CH₃)CH₂CH₃ (sec-butyl), —CH₂CH(CH₃)₂ (isobutyl), —C(CH₃)₃ (tert-butyl, t-butyl, t-Bu or ^{t}Bu), and —CH₂C(CH₃)₃ (neo-pentyl) are non-limiting examples of alkyl groups. The term “alkanediyl” when used without the “substituted” modifier refers to a divalent saturated aliphatic group, with one or two saturated carbon atom(s) as the point(s) of attachment, a linear or branched acyclic structure, no carbon-carbon double or triple bonds, and no atoms other than carbon and hydrogen. The groups —CH₂— (methylene), —CH₂CH₂—, —CH₂C(CH₃)₂CH₂—, and —CH₂CH₂CH₂— are non-limiting examples of alkanediyl groups. An “alkane” refers to the class of compounds having the formula H—R, wherein R is alkyl as this term is defined above. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. The following groups are non-limiting examples of substituted alkyl groups: —CH₂OH, —CH₂Cl, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂Cl. The term “haloalkyl” is a subset of substituted alkyl, in which the hydrogen atom replacement is limited to halo (i.e. —F, —Cl, —Br, or —I) such that no other atoms aside from carbon, hydrogen and halogen are present. The group, —CH₂Cl is a non-limiting example of a haloalkyl. The term “fluoroalkyl” is a subset of substituted alkyl, in which the hydrogen atom replacement is limited to fluoro such that no other atoms aside from carbon, hydrogen and fluorine are present. The groups —CH₂F, —CF₃, and —CH₂CF₃ are non-limiting examples of fluoroalkyl groups.

The term “cycloalkyl” when used without the “substituted” modifier refers to a monovalent saturated aliphatic group with a carbon atom as the point of attachment, said carbon atom forming part of one or more non-aromatic ring structures, no carbon-carbon double or triple bonds, and no atoms other than carbon and hydrogen. Non-limiting examples include: —CH(CH₂)₂ (cyclopropyl), cyclobutyl, cyclopentyl, or cyclohexyl (Cy). The term “cycloalkanediyl” when used without the “substituted” modifier refers to a divalent saturated aliphatic group with two carbon atoms as points of attachment, no carbon-carbon double or triple bonds, and no atoms other than carbon and hydrogen. The group

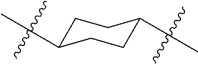 [SMILES: *C1CCC(*)CC1]

is a non-limiting example of cycloalkanediyl group. A “cycloalkane” refers to the class of compounds having the formula H—R, wherein R is cycloalkyl as this term is defined above.

When any of these terms is used with the “substituted” modifier one or more hydrogen atom has been independently replaced by —OH, —F, —Cl, —Br, —I, —NH₂, —NO₂, —CO₂H, CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “alkenyl” when used without the “substituted” modifier refers to an monovalent unsaturated aliphatic group with a carbon atom as the point of attachment, a linear or branched, acyclic structure, at least one nonaromatic carbon-carbon double bond, no carbon-carbon triple bonds, and no atoms other than carbon and hydrogen. Non-limiting examples include: —CH═CH₂ (vinyl), —CH═CHCH₃, —CH═CHCH₂CH₃, —CH₂CH═CH₂ (allyl), —CH₂CH═CHCH₃, and —CH═CHCH═CH₂. The term “alkenediyl” when used without the “substituted” modifier refers to a divalent unsaturated aliphatic group, with two carbon atoms as points of attachment, a linear or branched, a linear or branched acyclic structure, at least one nonaromatic carbon-carbon double bond, no carbon-carbon triple bonds, and no atoms other than carbon and hydrogen. The groups —CH═CH—, —CH═C(CH₃)CH₂—, —CH═CHCH₂—, and —CH₂CH═CHCH₂— are non-limiting examples of alkenediyl groups. It is noted that while the alkenediyl group is aliphatic, once connected at both ends, this group is not precluded from forming part of an aromatic structure. The terms “alkene” and “olefin” are synonymous and refer to the class of compounds having the formula H—R, wherein R is alkenyl as this term is defined above. When any of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. The groups —CH═CHF, —CH═CHCl and —CH═CHBr are non-limiting examples of substituted alkenyl groups.

The term “alkynyl” when used without the “substituted” modifier refers to a monovalent unsaturated aliphatic group with a carbon atom as the point of attachment, a linear or branched acyclic structure, at least one carbon-carbon triple bond, and no atoms other than carbon and hydrogen. As used herein, the term alkynyl does not preclude the presence of one or more non-aromatic carbon-carbon double bonds. The groups —C≡CH, —C≡CCH₃, and —CH₂C≡CCH₃ are non-limiting examples of alkynyl groups. An “alkyne” refers to the class of compounds having the formula H—R, wherein R is alkynyl. When any of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “aryl” when used without the “substituted” modifier refers to a monovalent unsaturated aromatic group with an aromatic carbon atom as the point of attachment, said carbon atom forming part of a one or more six-membered aromatic ring structure, wherein the ring atoms are all carbon, and wherein the group consists of no atoms other than carbon and hydrogen. If more than one ring is present, the rings may be fused or unfused. As used herein, the term does not preclude the presence of one or more alkyl or aralkyl groups (carbon number limitation permitting) attached to the first aromatic ring or any additional aromatic ring present. Non-limiting examples of aryl groups include phenyl (Ph), methylphenyl, (dimethyl)phenyl, —C₆H₄CH₂CH₃ (ethylphenyl), naphthyl, and a monovalent group derived from biphenyl. The term “arenediyl” when used without the “substituted” modifier refers to a divalent aromatic group with two aromatic carbon atoms as points of attachment, said carbon atoms forming part of one or more six-membered aromatic ring structure(s) wherein the ring atoms are all carbon, and wherein the monovalent group consists of no atoms other than carbon and hydrogen. As used herein, the term does not preclude the presence of one or more alkyl, aryl or aralkyl groups (carbon number limitation permitting) attached to the first aromatic ring or any additional aromatic ring present. If more than one ring is present, the rings may be fused or unfused. Unfused rings may be connected via one or more of the following: a covalent bond, alkanediyl, or alkenediyl groups (carbon number limitation permitting). Non-limiting examples of arenediyl groups include:

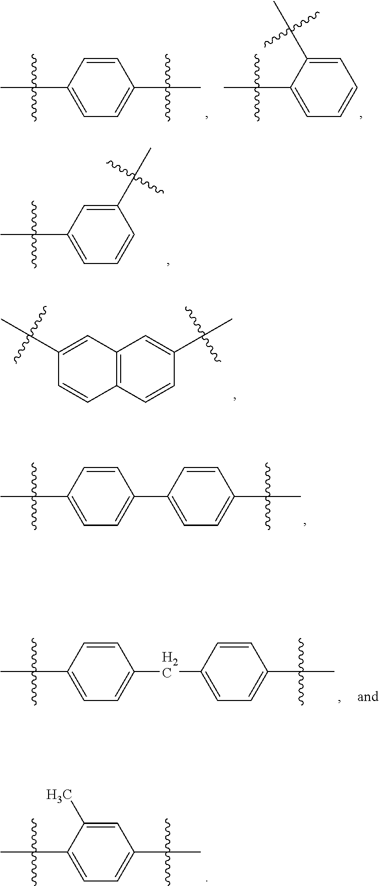

An “arene” refers to the class of compounds having the formula H—R, wherein R is aryl as that term is defined above. Benzene and toluene are non-limiting examples of arenes. When any of these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “aralkyl” when used without the “substituted” modifier refers to the monovalent group-alkanediyl-aryl, in which the terms alkanediyl and aryl are each used in a manner consistent with the definitions provided above. Non-limiting examples are: phenylmethyl (benzyl, Bn) and 2-phenyl-ethyl. When the term aralkyl is used with the “substituted” modifier one or more hydrogen atom from the alkanediyl and/or the aryl group has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. Non-limiting examples of substituted aralkyls are: (3-chlorophenyl)-methyl, and 2-chloro-2-phenyl-eth-1-yl.

The term “heteroaryl” when used without the “substituted” modifier refers to a monovalent aromatic group with an aromatic carbon atom or nitrogen atom as the point of attachment, said carbon atom or nitrogen atom forming part of one or more aromatic ring structures wherein at least one of the ring atoms is nitrogen, oxygen or sulfur, and wherein the heteroaryl group consists of no atoms other than carbon, hydrogen, aromatic nitrogen, aromatic oxygen and aromatic sulfur. If more than one ring is present, the rings may be fused or unfused. As used herein, the term does not preclude the presence of one or more alkyl, aryl, and/or aralkyl groups (carbon number limitation permitting) attached to the aromatic ring or aromatic ring system. Non-limiting examples of heteroaryl groups include furanyl, imidazolyl, indolyl, indazolyl (Im), isoxazolyl, methylpyridinyl, oxazolyl, phenylpyridinyl, pyridinyl (pyridyl), pyrrolyl, pyrimidinyl, pyrazinyl, quinolyl, quinazolyl, quinoxalinyl, triazinyl, tetrazolyl, thiazolyl, thienyl, and triazolyl. The term “N-heteroaryl” refers to a heteroaryl group with a nitrogen atom as the point of attachment. A “heteroarene” refers to the class of compounds having the formula H—R, wherein R is heteroaryl. Pyridine and quinoline are non-limiting examples of heteroarenes. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “heterocycloalkyl” when used without the “substituted” modifier refers to a monovalent non-aromatic group with a carbon atom or nitrogen atom as the point of attachment, said carbon atom or nitrogen atom forming part of one or more non-aromatic ring structures wherein at least one of the ring atoms is nitrogen, oxygen or sulfur, and wherein the heterocycloalkyl group consists of no atoms other than carbon, hydrogen, nitrogen, oxygen and sulfur. If more than one ring is present, the rings may be fused or unfused. As used herein, the term does not preclude the presence of one or more alkyl groups (carbon number limitation permitting) attached to the ring or ring system. Also, the term does not preclude the presence of one or more double bonds in the ring or ring system, provided that the resulting group remains non-aromatic. Non-limiting examples of heterocycloalkyl groups include aziridinyl, azetidinyl, pyrrolidinyl, piperidinyl, piperazinyl, morpholinyl, thiomorpholinyl, tetrahydrofuranyl, tetrahydrothiofuranyl, tetrahydropyranyl, pyranyl, oxiranyl, and oxetanyl. The term “N-heterocycloalkyl” refers to a heterocycloalkyl group with a nitrogen atom as the point of attachment. N-pyrrolidinyl is an example of such a group. When these terms are used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “acyl” when used without the “substituted” modifier refers to the group —C(O)R, in which R is a hydrogen, alkyl, cycloalkyl, or aryl as those terms are defined above. The groups, —CHO, —C(O)CH₃ (acetyl, Ac), —C(O)CH₂CH₃, —C(O)CH(CH₃)₂, —C(O)CH(CH₂)₂, —C(O)C₆H₅, and —C(O)C₆H₄CH₃ are non-limiting examples of acyl groups. A “thioacyl” is defined in an analogous manner, except that the oxygen atom of the group —C(O)R has been replaced with a sulfur atom, —C(S)R. The term “aldehyde” corresponds to an alkyl group, as defined above, attached to a —CHO group. When any of these terms are used with the “substituted” modifier one or more hydrogen atom (including a hydrogen atom directly attached to the carbon atom of the carbonyl or thiocarbonyl group, if any) has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups.

The term “alkoxy” when used without the “substituted” modifier refers to the group —OR, in which R is an alkyl, as that term is defined above. Non-limiting examples include: —OCH₃ (methoxy), —OCH₂—CH₃ (ethoxy), —OCH₂CH₂CH₃, —OCH(CH₃)₂ (isopropoxy), —OC(CH₃)₃ (tert-butoxy), —OCH(CH₂)₂, —O-cyclopentyl, and —O-cyclohexyl. The terms “cycloalkoxy”, “alkenyloxy”, “alkynyloxy”, “aryloxy”, “aralkoxy”, “heteroaryloxy”, “heterocycloalkoxy”, and “acyloxy”, when used without the “substituted” modifier, refers to groups, defined as —OR, in which R is cycloalkyl, alkenyl, alkynyl, aryl, aralkyl, heteroaryl, heterocycloalkyl, and acyl, respectively. The term “alkylthio” and “acylthio” when used without the “substituted” modifier refers to the group —SR, in which R is an alkyl and acyl, respectively. The term “alcohol” corresponds to an alkane, as defined above, wherein at least one of the hydrogen atoms has been replaced with a hydroxy group. The term “ether” corresponds to an alkane, as defined above, wherein at least one of the hydrogen atoms has been replaced with an alkoxy group. When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The term “alkylamino” when used without the “substituted” modifier refers to the group —NHR, in which R is an alkyl, as that term is defined above. Non-limiting examples include: —NHCH₃ and —NHCH₂CH₃. The term “dialkylamino” when used without the “substituted” modifier refers to the group —NRR′, in which R and R′ can be the same or different alkyl groups, or R and R′ can be taken together to represent an alkanediyl. Non-limiting examples of dialkylamino groups include: —N(CH₃)₂ and —N(CH₃)(CH₂CH₃). The terms “cycloalkylamino”, “alkenylamino”, “alkynylamino”, “arylamino”, “aralkylamino”, “heteroarylamino”, “heterocycloalkylamino”, “alkoxyamino”, and “alkylsulfonylamino” when used without the “substituted” modifier, refers to groups, defined as —NHR, in which R is cycloalkyl, alkenyl, alkynyl, aryl, aralkyl, heteroaryl, heterocycloalkyl, alkoxy, and alkylsulfonyl, respectively. A non-limiting example of an arylamino group is —NHC₆H₅. The term “amido” (acylamino), when used without the “substituted” modifier, refers to the group —NHR, in which R is acyl, as that term is defined above. A non-limiting example of an amido group is —NHC(O)CH₃. The term “alkylimino” when used without the “substituted” modifier refers to the divalent group ═NR, in which R is an alkyl, as that term is defined above. When any of these terms is used with the “substituted” modifier one or more hydrogen atom attached to a carbon atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. The groups —NHC(O)OCH₃ and —NHC(O)NHCH₃ are non-limiting examples of substituted amido groups.

The terms “alkylsulfonyl” and “alkylsulfinyl” when used without the “substituted” modifier refers to the groups —S(O)₂R and —S(O)R, respectively, in which R is an alkyl, as that term is defined above. The terms “cycloalkylsulfonyl”, “alkenylsulfonyl”, “alkynylsulfonyl”, “arylsulfonyl”, “aralkylsulfonyl”, “heteroarylsulfonyl”, and “heterocycloalkylsulfonyl” are defined in an analogous manner When any of these terms is used with the “substituted” modifier one or more hydrogen atom has been independently replaced by —OH, —F, —Cl, —Br, —I, —NH₂, —NO₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂.

The use of the word “a” or “an,” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the inherent variation of error for the device, the method being employed to determine the value, or the variation that exists among the study subjects.

An “amine protecting group” is well understood in the art. An amine protecting group is a group which prevents the reactivity of the amine group during a reaction which modifies some other portion of the molecule and can be easily removed to generate the desired amine. Amine protecting groups can be found at least in Greene and Wuts, 1999, which is incorporated herein by reference. Some non-limiting examples of amino protecting groups include formyl, acetyl, propionyl, pivaloyl, t-butylacetyl, 2-chloroacetyl, 2-bromoacetyl, trifluoroacetyl, trichloroacetyl, o-nitrophenoxyacetyl, α-chlorobutyryl, benzoyl, 4-chlorobenzoyl, 4-bromobenzoyl, 4-nitrobenzoyl, and the like; sulfonyl groups such as benzenesulfonyl, p-toluenesulfonyl and the like; alkoxy- or aryloxycarbonyl groups (which form urethanes with the protected amine) such as benzyloxycarbonyl (Cbz), p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, α,α-dimethyl-3,5-dimethoxybenzyloxycarbonyl, benzhydryloxycarbonyl, t-butyloxycarbonyl (Boc), diisopropylmethoxycarbonyl, isopropyloxycarbonyl, ethoxycarbonyl, methoxycarbonyl, allyloxycarbonyl (Alloc), 2,2,2-trichloroethoxycarbonyl, 2-trimethylsilylethyloxycarbonyl (Teoc), phenoxycarbonyl, 4-nitrophenoxycarbonyl, fluorenyl-9-methoxycarbonyl (Fmoc), cyclopentyloxycarbonyl, adamantyloxycarbonyl, cyclohexyloxycarbonyl, phenylthiocarbonyl and the like; aralkyl groups such as benzyl, triphenylmethyl, benzyloxymethyl and the like; and silyl groups such as trimethylsilyl and the like. Additionally, the “amine protecting group” can be a divalent protecting group such that both hydrogen atoms on a primary amine are replaced with a single protecting group. In such a situation the amine protecting group can be phthalimide (phth) or a substituted derivative thereof wherein the term “substituted” is as defined above. In some embodiments, the halogenated phthalimide derivative may be tetrachlorophthalimide (TCphth). When used herein, a “protected amino group”, is a group of the formula PG_{MA}NH— or PG_{DA}N— wherein PG_{MA} is a monovalent amine protecting group, which may also be described as a “monvalently protected amino group” and PG_{DA} is a divalent amine protecting group as described above, which may also be described as a “divalently protected amino group”.

A “hydroxyl protecting group” is well understood in the art. A hydroxyl protecting group is a group which prevents the reactivity of the hydroxyl group during a reaction which modifies some other portion of the molecule and can be easily removed to generate the desired hydroxyl. Hydroxyl protecting groups can be found at least in Greene and Wuts, 1999, which is incorporated herein by reference. Some non-limiting examples of hydroxyl protecting groups include acyl groups such as formyl, acetyl, propionyl, pivaloyl, t-butylacetyl, 2-chloroacetyl, 2-bromoacetyl, trifluoroacetyl, trichloroacetyl, o-nitrophenoxyacetyl, α-chlorobutyryl, benzoyl, 4-chlorobenzoyl, 4-bromobenzoyl, 4-nitrobenzoyl, and the like; sulfonyl groups such as benzenesulfonyl, p-toluenesulfonyl and the like; acyloxy groups such as benzyloxycarbonyl (Cbz), p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, α,α-dimethyl-3,5-dimethoxybenzyloxycarbonyl, benzhydryloxycarbonyl, t-butyloxycarbonyl (Boc), diisopropylmethoxycarbonyl, isopropyloxycarbonyl, ethoxycarbonyl, methoxycarbonyl, allyloxycarbonyl (Alloc), 2,2,2-trichloroethoxycarbonyl, 2-trimethylsilylethyloxycarbonyl (Teoc), phenoxycarbonyl, 4-nitrophenoxycarbonyl, fluorenyl-9-methoxycarbonyl (Fmoc), cyclopentyloxycarbonyl, adamantyloxycarbonyl, cyclohexyloxycarbonyl, phenylthiocarbonyl and the like; aralkyl groups such as benzyl, triphenylmethyl, benzyloxymethyl and the like; and silyl groups such as trimethylsilyl and the like. When used herein, a protected hydroxy group is a group of the formula PG_{H}O— wherein PG_{H} is a hydroxyl protecting group as described above.

A “thiol protecting group” is well understood in the art. A thiol protecting group is a group which prevents the reactivity of the mercapto group during a reaction which modifies some other portion of the molecule and can be easily removed to generate the desired mercapto group. Thiol protecting groups can be found at least in Greene and Wuts, 1999, which is incorporated herein by reference. Some non-limiting examples of thiol protecting groups include acyl groups such as formyl, acetyl, propionyl, pivaloyl, t-butylacetyl, 2-chloroacetyl, 2-bromoacetyl, trifluoroacetyl, trichloroacetyl, o-nitrophenoxyacetyl, α-chlorobutyryl, benzoyl, 4-chlorobenzoyl, 4-bromobenzoyl, 4-nitrobenzoyl, and the like; sulfonyl groups such as benzenesulfonyl, p-toluenesulfonyl and the like; acyloxy groups such as benzyloxycarbonyl (Cbz), p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, α,α-dimethyl-3,5-dimethoxybenzyloxycarbonyl, benzhydryloxycarbonyl, t-butyloxycarbonyl (Boc), diisopropylmethoxycarbonyl, isopropyloxycarbonyl, ethoxycarbonyl, methoxycarbonyl, allyloxycarbonyl (Alloc), 2,2,2-trichloroethoxycarbonyl, 2-trimethylsilylethyloxycarbonyl (Teoc), phenoxycarbonyl, 4-nitrophenoxycarbonyl, fluorenyl-9-methoxycarbonyl (Fmoc), cyclopentyloxycarbonyl, adamantyloxycarbonyl, cyclohexyloxycarbonyl, phenylthiocarbonyl and the like; aralkyl groups such as benzyl, triphenylmethyl, benzyloxymethyl and the like; and silyl groups such as trimethylsilyl and the like. When used herein, a protected thiol group is a group of the formula PG_{T}S— wherein PG_{T} is a thiol protecting group as described above.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The term “curing agent” is a compound which reacts with one or more groups within the resin starting material to strengthen or harder the polymer of the resin groups. In some embodiments, the curing agent may cross link the resin polymer to increase the toughness or harden the resin. The curing agents may contain two functional groups which can react with the groups of the resin and the resultant resin polymer. Some non-limiting examples of curing agents include alcohols, phenols, thiols, aldehydes, anhydrides, acids, or amines. In the context of curing agents, an alcohol curing agent is a group containing two or more —OH groups or a compound with an alcohol and one or more reactive functional groups. For phenols, the curing agent contains either two or more —OH group which is bound to an aromatic ring or one OH group which is bound to an aromatic ring and one or more reactive functional groups. Similarly, a thiol curing agent, an aldehyde curing agent, or an acid curing agent are similar except the base functional group is —SH, —C(O)H, or —CO₂H, respectively. On the other hand, an amine curing agent contains one or more amine groups or an amine group and one or more other reactive functional groups. In the context of a curing agent, the amine in the amine curing agent is —NH₂, a primary amine, or a secondary amine Similarly, an anhydride curing agent is an agent which contains the functional group —C(O)OC(O)— wherein the group is attached two hydrogen atoms, alkyl, cycloalkyl, alkenyl, alkynyl, aryl, or aralkyl with C1-C30 carbon atoms. In other embodiments, the anhydride functional group is joined together and is a cycloalkyl group or an aliphatic ring system containing one or more carbon carbon double bonds or carbon carbon triple bonds, or is an arenediyl group wherein these groups contain from 1 to 30 carbon atoms.

The term “effective,” as that term is used in the specification and/or claims, means adequate to accomplish a desired, expected, or intended result.

The term “epoxide” is a chemical group containing a three membered ring with one of the ring atoms is an oxygen atom. In some aspects, the present disclosure relates to compounds which have been reacted with a compound to attached an epoxide to the aromatic compound. The epoxide group is attached to the aromatic compound by an alkanediyl, alkenediyl, or arenediyl as those terms are defined above with from 1 carbon atom to 12 carbon atoms. When the epoxide group is attached to a hydroxy group, the group is attached as either an ether or an ester group. Alternatively, when the epoxide group is attached to a carboxylic group, then the group is attached as either an ester or an amide.

An “isomer” of a first compound is a separate compound in which each molecule contains the same constituent atoms as the first compound, but where the configuration of those atoms in three dimensions differs.

A “stereoisomer” or “optical isomer” is an isomer of a given compound in which the same atoms are bonded to the same other atoms, but where the configuration of those atoms in three dimensions differs. “Enantiomers” are stereoisomers of a given compound that are mirror images of each other, like left and right hands. “Diastereomers” are stereoisomers of a given compound that are not enantiomers. Chiral molecules contain a chiral center, also referred to as a stereocenter or stereogenic center, which is any point, though not necessarily an atom, in a molecule bearing groups such that an interchanging of any two groups leads to a stereoisomer. In organic compounds, the chiral center is typically a carbon, phosphorus or sulfur atom, though it is also possible for other atoms to be stereocenters in organic and inorganic compounds. A molecule can have multiple stereocenters, giving it many stereoisomers. In compounds whose stereoisomerism is due to tetrahedral stereogenic centers (e.g., tetrahedral carbon), the total number of hypothetically possible stereoisomers will not exceed 2ⁿ, where n is the number of tetrahedral stereocenters. Molecules with symmetry frequently have fewer than the maximum possible number of stereoisomers. A 50:50 mixture of enantiomers is referred to as a racemic mixture. Alternatively, a mixture of enantiomers can be enantiomerically enriched so that one enantiomer is present in an amount greater than 50%. Typically, enantiomers and/or diastereomers can be resolved or separated using techniques known in the art. It is contemplated that that for any stereocenter or axis of chirality for which stereochemistry has not been defined, that stereocenter or axis of chirality can be present in its R form, S form, or as a mixture of the R and S forms, including racemic and non-racemic mixtures. As used herein, the phrase “substantially free from other stereoisomers” means that the composition contains ≤15%, more preferably ≤10%, even more preferably ≤5%, or most preferably ≤1% of another stereoisomer(s).

The above definitions supersede any conflicting definition in any reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

### V. EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

### Methods and Materials

A. Materials

All chemicals were purchased from Sigma-Aldrich unless otherwise noted below. Two phenolic acids were used in this study: salicylic acid (SA, ≥99%, FG/Halal/Kosher) and 4-hydroxybenzoic acid (4HBA, 99%, ReagentPlus). The chemical structures of both phenolic acids are shown below. Multiple curing agents and catalysts were used: methylhexahydrophthalic anhydride (MHHPA, Huntsman, Aradur® HY 1102, ≥99%), 1-methyl-imidazole (1-MI, Huntsman, Accelerator DY 070), nadic methyl anhydride (NMA, ≥95%), 2,4,6-tris(dimethylaminomethyl) phenol (Ancamine® K54, Air Products, <95%), diethylenetriamine (DETA, Dow Chemical, D.E.H.™ 20, ≥98.5%), triethylenetetramine (TETA, Dow Chemical, D.E.H.™ 20, ≥96%), isophorondiamine (IPDA, Huntsman, Aradur® 42, 99.8%), and meta-xylenediamine (MXDA, Huntsman, Aradur® 22). The chemical structures of the curing agents are shown below.

### Compound a) salicylic acid (SA) and Compound b) 4-hydroxybenzoic acid (4HBA)

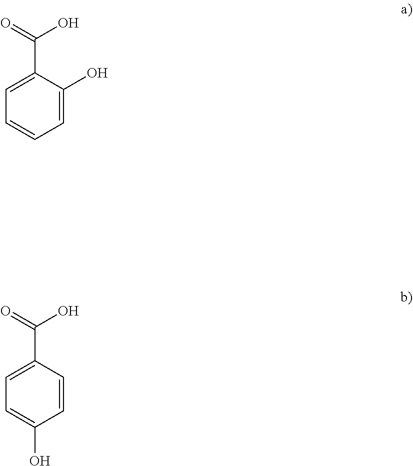 [SMILES: O=C(O)c1ccccc1O ; O=C(O)c1ccc(O)cc1]

Other chemicals used were N,N-dimethylformamide (DMF, BDH, ≥99.8%, ACS reagent), potassium carbonate (K₂CO₃, ≥99.0%, ACS reagent), allyl bromide (97%), ethyl acetate (BDH, ≥99.5%, ACS grade), magnesium sulfate (MgSO₄, BDH, ≥99.0%, anhydrous reagent grade), 2,2-dimethoxy-2-phenylacetophenone (DMPA, 99%), pentaerythritol tetrakis(3-mercaptopropionate) (PETMP, >95%), meta-chloroperoxybenzoic acid (mCPBA, ≤77%), sodium sulfite (Na₂SO₃, AMRESCO, 98.0%, ACS grade), sodium bicarbonate (NaHCO₃, ACS reagent, 99.7-100.3%), petroleum ethers (Macron, 30°-75° C.), chloroform (Macron, ACS grade), and silica gel (Macron, Grade 62, 60-200 Mesh).

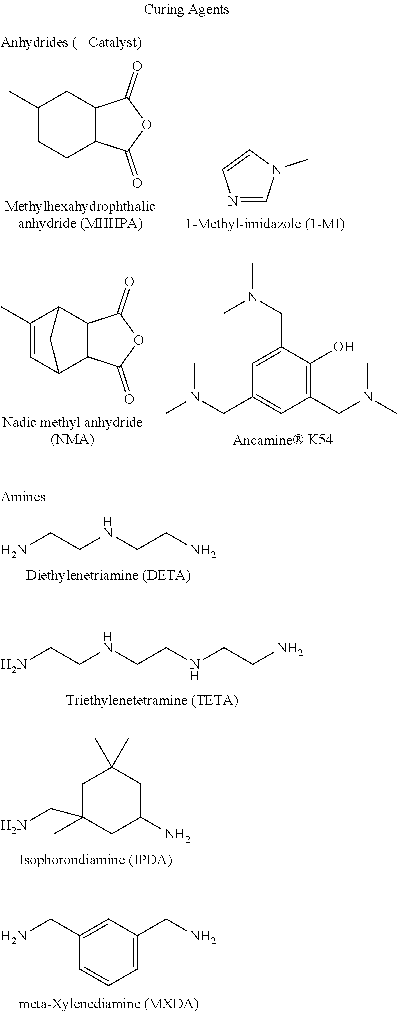

B. Nuclear Magnetic Resonance (NMR)

¹H NMR (400 MHz) and ¹³C NMR (100 MHz) experiments were performed on a JEOL ECA-400 instrument using deuterated chloroform (Cambridge Isotope

Laboratories, Inc., 99.9% D) as the solvent. Chemical shifts were referenced to the solvent proton resonance (7.26 ppm).

C. Fourier Transform Infrared Spectroscopy (FTIR)

FTIR spectra were recorded on a Thermo Scientific Nicolet 4700 spectrometer in transmission mode as well as using an attenuated total reflection (ATR) stage (containing a Germanium crystal). The OMNIC Series software was used to follow selected peaks at 1.928 cm⁻¹ resolution using 32 scans. FTIR spectra were collected on epoxidized monomers and epoxy networks.

D. Monomer Synthesis

The procedures for allylation of SA and 4HBA have been previously reported in Yang, et al., 2015. Phenolic acid (10.0 g, 72.4 mmol) was dissolved into 340 mL DMF in a 1000 mL glass round-bottom flask equipped with a rubber septum and a magnetic stirring bar. The temperature was maintained at 0° C. using an ice bath. K₂CO₃ (22.0 g, 159 mmol) was added to the flask (the molar ratio of K₂CO₃ to phenolic acid was 2.20 to 1.00). After 3 min of stirring, allyl bromide (19.3 g, 159 mmol) was added dropwise with a syringe (the molar ratio of allyl bromide to the phenolic acid was 2.20 to 1.00). The solution was stirred at room temperature for 48 h. Distilled water (340 mL) was added and the product was isolated by extraction with ethyl acetate (3×), washing with saturated brine, drying over MgSO₄, and concentration in vacuo, followed by drying in a vacuum oven at 50° C., until the NMR peaks associated with DMF (7.96 ppm, 2.94 ppm, 2.78 ppm) were not observed. Characterization data for allylated SA and 4HBA were reported in Yang, et al., 2015.

The epoxidation of allylated phenolic acid (SA and 4HBA) was conducted following literature procedures for conversion of the allyl groups to epoxide groups (Aouf, et al., 2013). Allylated phenolic acid (5.00 g, 22.9 mmol) was dissolved into 500 mL chloroform in a 1000 mL glass round bottom flask equipped with a rubber septum and a magnetic stirring bar. mCPBA (31.6 g, 183 mmol) was added to the flask (molar ratio of mCPBA to allylated phenolic acid was 8.00 to 1.00). The solution was stirred at 40° C. for 24 h. Next, the solution was washed with an equivalent volume of a 10% (wt/v) Na₂SO₃ aqueous solution and recovered using a separatory funnel. The organic phase was then washed with an equivalent volume of a saturated NaHCO₃ aqueous solution, and recovered using a separatory funnel. Finally, the organic phase was washed with an equivalent volume of distilled water, and recovered using a separatory funnel. The chloroform was then removed from the product using a rotary evaporator. The epoxidized salicylic acid (ESA) product was purified by silica gel chromatography using petroleum ethers/ethyl acetate (80/20), while the epoxidized 4-hydroxybenzoic acid (E4HBA) product was purified by silica gel chromatography using petroleum ethers/chloroform (80/20). The organic solvent was removed using a rotary evaporator and the product was dried in a vacuum oven at 50° C. overnight.

Epoxidized salicylic acid (referred to as “ESA” herein): ¹H NMR (400 MHz, chloroform-d, ppm): δ 7.85 (dd, J=7.79, 0.92 Hz, 1H), 7.47 (ddd, J=7.79, 7.79, 1.83 Hz, 1H), 7.01 (ddd, J=7.79, 7.79, 0.92 Hz, 1H), 6.98 (d, J=8.24 Hz, 1H), 4.62 (ddd, J=12.36, 3.21, 3.21 Hz, 1H), 4.33 (dd, J=11.22, 3.21 Hz, 1H), 4.20-4.13 (m, 1H), 4.08 (dd, J=11.22, 5.04 Hz, 1H), 3.43-3.39 (m, 1H), 3.36-3.32 (m, 1H), 2.95-2.88 (m, 3H), 2.77-2.74 (m, 1H). ¹³C NMR (100 MHz; chloroform-d, ppm): δ 165.8, 158.3, 133.9, 132.1, 121.0, 120.2, 113.9, 69.4, 65.4, 65.2, 50.2, 49.6, 44.8. FTIR (ATR) 1724, 1601, 1583, 1491, 1450, 1382, 1344, 1301, 1245, 1167, 1132, 1085, 1074, 1049, 1023, 972, 909, 844, 756, 703, 662, 644, 634, 624, 607 cm⁻¹.

Epoxidized 4-hydroxybenzoic acid (referred to as “E4HBA” herein): ¹H NMR (400 MHz, chloroform-d, ppm): δ 8.02 (d, J=9.16 Hz, 2H), 6.94 (d, J=9.16 Hz, 2H), 4.63 (dd, J=12.60, 2.86 Hz, 1H), 4.30 (dd, J=11.17, 2.86 Hz, 1H), 4.13 (dd, J=12.03, 6.3 Hz, 1H), 3.99 (dd, J=11.17, 6.30 Hz, 1H), 3.39-3.36 (m, 1H), 3.35-3.31 (m, 1H), 2.93 (dd, J=4.58, 4.58 Hz, 1H), 2.89 (dd, J=4.58, 4.58 Hz, 1H), 2.77 (dd, J=5.15, 2.86 Hz, 1H), 2.72 (dd, J=5.15, 2.86 Hz, 1H). ¹³C NMR (100 MHz; chloroform-d, ppm): δ 166.0, 162.5, 131.9, 122.7, 114.3, 68.9, 65.3, 50.0, 49.7, 44.8, 44.7. FTIR (ATR) 1703, 1606, 1582, 1511, 1483, 1451, 1423, 1344, 1304, 1273, 1258, 1173, 1138, 1112, 1104, 1077, 1033, 991, 971, 914, 906, 882, 864, 843, 811, 767, 693, 669, 649, 633, 611 cm⁻¹.

E. Epoxy Resin Curing Protocol

The epoxidized phenolic acid (1.00 g, 4.00 mmol) was mixed with MHHPA (1.35 g, 8.00 mmol, stoichiometry based on equal molar functional groups) and 3 phr (parts per hundred resin) of the catalyst 1-MI (0.03 g, 0.0365 mmol) at 50° C. in a 20 mL vial (using magnetic stirring). The mixture was placed in the following sample holders appropriate for each characterization experiment: a) in a preweighed Tzero aluminum pan for differential scanning calorimetry, b) in a pan for thermogravimetric analysis, c) between two NaCl windows (32 mm diameter, 3 mm thick) with a 0.05 mm Teflon spacer for transmission-mode FTIR, and d) in a aluminum dogbone-shaped mold following ASTM D638 (bar type 5, thickness 1.6 mm) for tensile testing. The sample was then transferred to a convection oven and cured according to the following protocol: 70° C. for 2 h, 170° C. for 2 h.

F. Differential Scanning Calorimetry (DSC)

DSC experiments were conducted to monitor in situ curing of the epoxy resins. A TA Instruments Q2000 modulated differential scanning calorimeter, calibrated with an indium standard, with a nitrogen flow rate of 50 mL/min, was used for this purpose. The epoxy resin components (DGEBA, ESA or E4HBA, as well as curing agent and catalyst) were mixed at 50° C. and placed in a preweighed Tzero aluminum pan. The pan was transferred to the differential scanning calorimeter, equilibrated at 40° C. and heated to 200° C. at a rate of 10° C./min to examine the curing behavior at constant heating rate.

The glass transition temperatures (T_{g}) of specimens prepared through various curing protocols (specimens cured at constant heating rate in the DSC, as well as specimens prepared in a convection oven for tensile testing) were measured through DSC experiments. The cured sample was placed in the calorimeter (using a Tzero aluminum pan), equilibrated at 40° C., heated to 200° C. at a rate of 10° C./min, cooled to 40° C. at a rate of 10° C./min and heated to 200° C. at a rate of 10° C./min The value of the T_{g} was determined using the half extrapolated tangents method in the Universal Analysis software.

G. Thermogravimetric Analysis (TGA)

TGA experiments were conducted with a TA Instruments Q500 analyzer. The epoxy resin components (DGEBA. ESA or E4HBA plus MHHPA and 1-MI) were mixed at 50° C. and transferred to the analyzer. The cured sample was heated from 25° C. to 550° C. at a rate of 10° C./min in an argon environment (the balance argon purge flow was 40 mL/min and the sample purge flow was 60 mL/min).

H. Tensile Testing

Tensile testing was carried out with an Instron 5966 universal testing system containing a 2 kN load cell. Dogbone-shaped testing bars (ASTM D638, bar type 5, thickness 1.5 mm) were prepared following the curing protocol described above. Pneumatic grips (maximum force 2 kN) were used to affix the sample in the testing frame, at a compressed air pressure of 80 psi. The force and change in length were measured as the sample was elongated at a rate of 1 mm/min The engineering stress was calculated using the measured force and cross-sectional area of the sample. The engineering strain was measured directly using an Instron extensometer (gauge length 0.3 inch, travel ±0.15 inch). Each tensile measurement was repeated with 5 test specimens that broke in the gauge region and did not contain a visible defect at the point of fracture.

I. Scanning Electron Microscopy (SEM)

SEM micrographs of the fracture surfaces of tensile bars were imaged using a LEO 1525 field emission scanning electron microscope at a voltage of 15 kV. The fracture surface was etched with ionized argon gas and subsequently coated with gold using a Denton Vacuum Desk V sputter coater. The gold thickness was approximately 10 nm. The resulting micrographs were converted to binary images and analyzed with ImageJ to determine the areas of each feature (parabolic and elliptical features). Parabolic and elliptical features were manually distinguished from one another.

### EXAMPLE 2

### Results and Discussion

A. Synthesis of Epoxidized Phenolic Acids

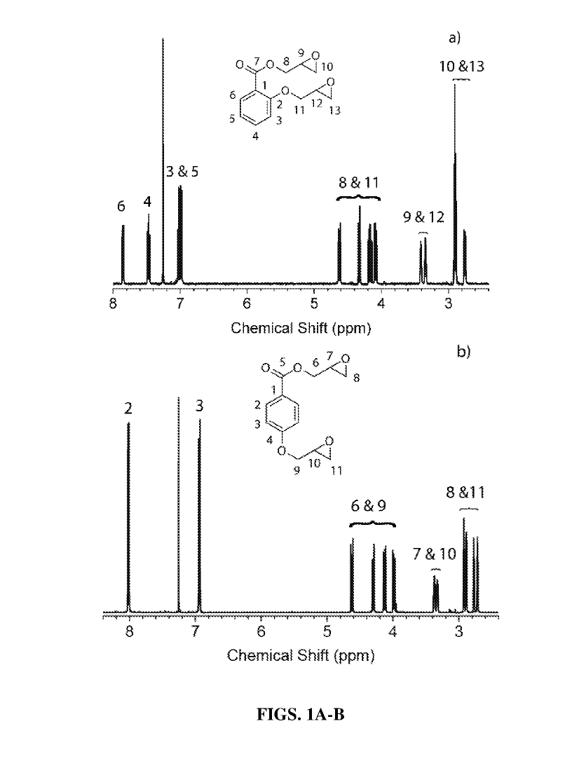

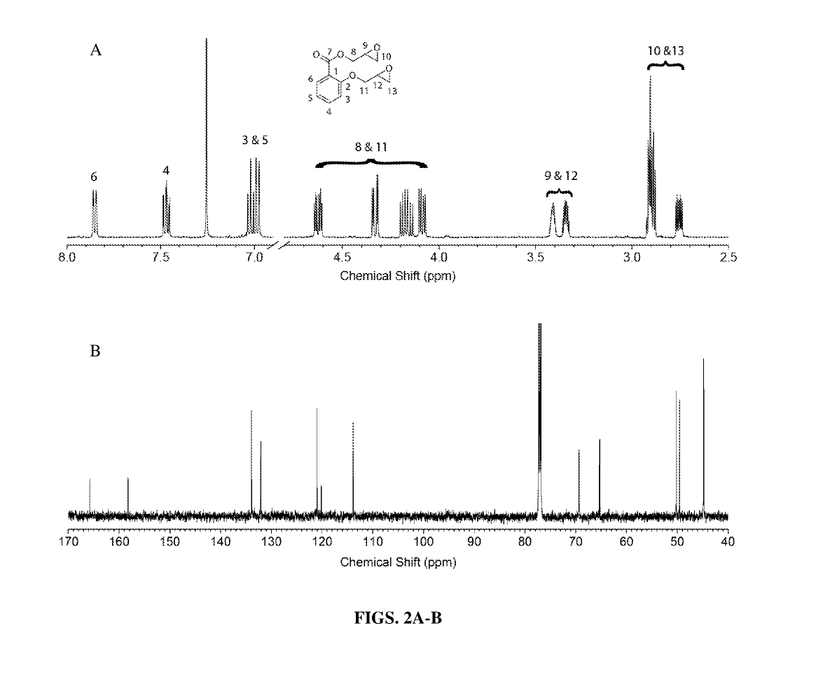

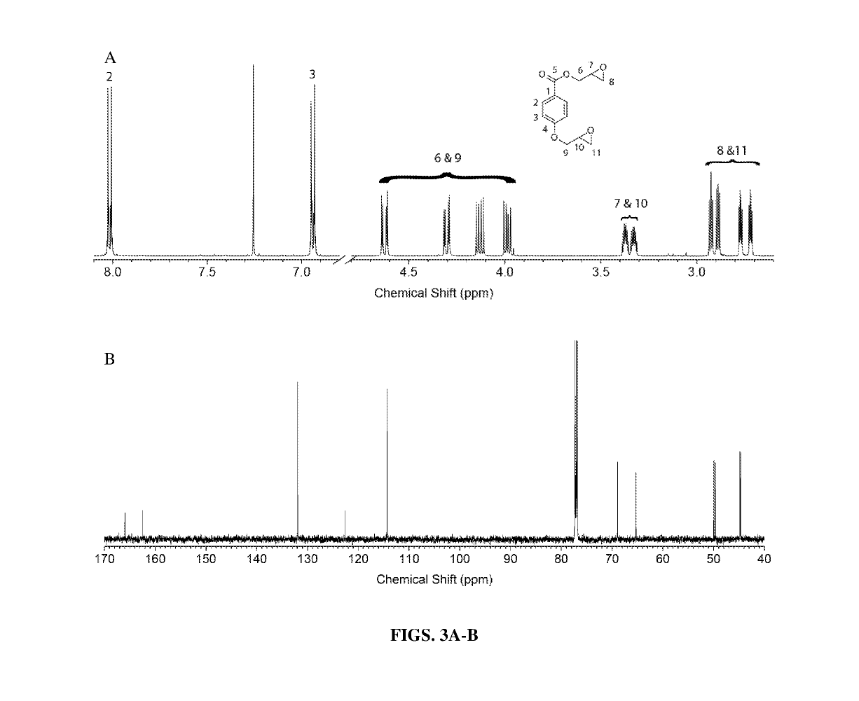

SA was allylated and subsequently epoxidized to produce ESA (Scheme 1a). ¹H NMR data obtained from ESA are shown in FIG. 1A. Peaks located in the region of 4.7-2.7 ppm correspond to the glycidyl groups in ESA. The ratio of the peak area associated with the CH₂—O protons on the glycidyl group (4.65-4.05 ppm) to the peak area associated with the aromatic protons (7.89-6.95 ppm) should theoretically be 4:4 if there is complete conversion of the carboxyl and hydroxyl groups to allyl groups. Using the data shown in FIG. 1A, this ratio is 4.12:4.00, which is very close to the theoretical prediction. The absence of peaks associated with the allyl groups of the allylated salicylic acid precursor to ESA was noted [4.81-4.61 ppm (OCH₂ in allyl group), 6.10-5.98 ppm (—CH═ in allyl group), 5.53-5.25 ppm (═CH₂ in allyl group), reported in in Yang, et al., 2015]. The conversion of SA to ESA was 99%, and ESA was isolated in a 70% yield. The allylated 4-hydroxybenzoic acid (4HBA) was epoxidized following the same procedures (Scheme 1b, NMR data shown in FIG. 1B). The conversion of 4HBA to E4HBA was 99%, and E4HBA was isolated in a 48% yield. These results are summarized in Table 1.

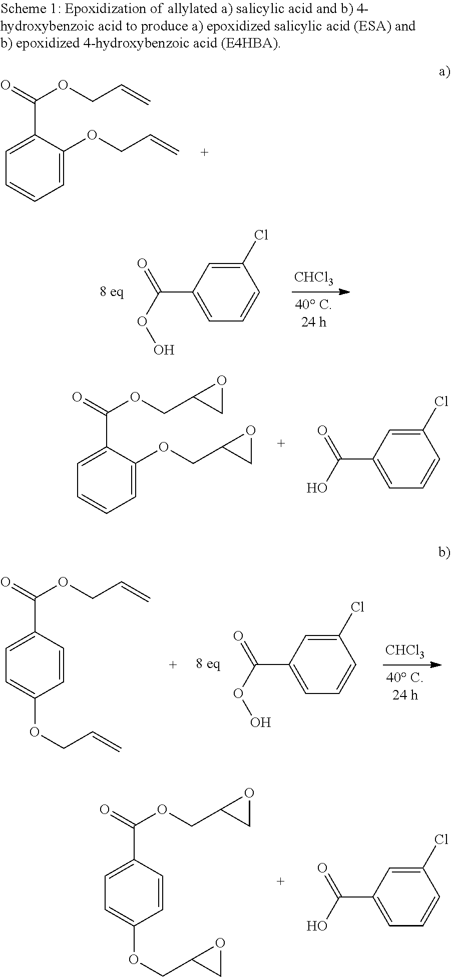

TABLE 1
¹H NMR Characterization of Allylated Phenolic Acid Epoxidation

| phenolic | % | peak area of CH₂O on glycidyl group:peak | % |
|---|---|---|---|
| acid | conversion | area of aromatic protons^{a} | yield |
| SA | 99% | 4.12:4.00 (4:4) | 70% |
| 4HBA | 99% | 4.09:4.00 (4:4) | 48% |

^{a}Theoretical ratio is given in parentheses

B. Selection of Curing Agent for Epoxidized Phenolic Acids

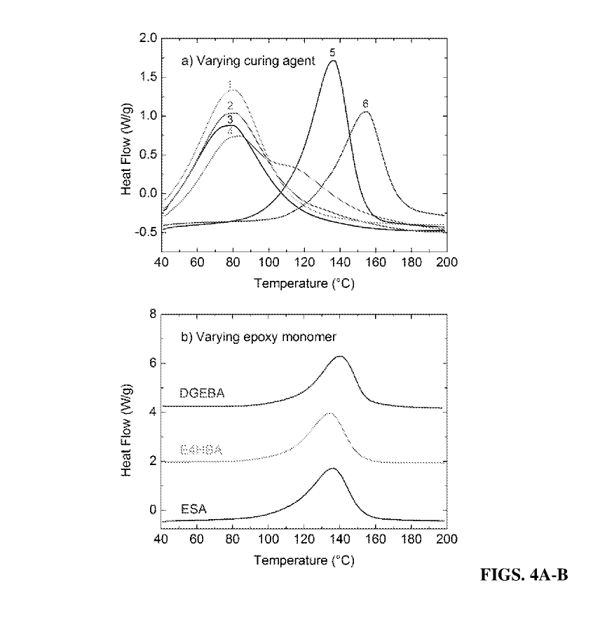

The curing reactions between ESA and E4HBA and various curing agents were monitored through in situ DSC, using a dynamic temperature scan: the temperature was heated from 40 to 200° C., cooled back to 40° C., and subsequently heated to 200° C.; each step was conducted at a rate of 10° C./min The curing reactions between ESA and various curing agents were explored in order to inform the choice of proper curing agent (FIG. 4A): aliphatic amines (DETA, TETA), a cycloaliphatic amine (IPDA), an aliphatic aromatic amine (MXDA), and anhydrides with catalyst (MHHPA+3 phr 1-MI, NMA+3 phr Ancamine K54). The ratio of epoxy resin to curing agent was held at the stoichiometric ratio of respective functional groups. When ESA was cured with an amine, the resin exhibited a relatively low curing temperature (maximum of the exothermic peak was below 100° C.), regardless of the choice of amine By contrast, when ESA was cured with anhydride in a catalyzed reaction, the required curing temperature was higher (maximum of the exothermic peak was above 100° C.). The T_{g}'s of each ESA-based epoxy resin, cured with various choices of curing agents, were also characterized (Table 2). The T_{g} of the ESA-based epoxy resins were systematically lower than that of DGEBA-based epoxy resins (cured with the same choices of curing agents). In the case of the amine curing agents, the differences in T_{g} of the two types of epoxy resins (ESA and DGEBA-based) were quite large (in the range of 30-50° C.), whereas the anhydride curing agents produced epoxy resins with more similar T_{g}'s (differing by <20° C.). The MHHPA anhydride curing agent (catalyzed by 1-MI) was chosen for subsequent studies due to the advantageous high T_{g} of the ESA epoxy resin (138° C., compared to 155° C. for the DBEGA-based epoxy resin cured with the same curing agent). A comparison of the DSC data obtained during curing of ESA, E4HBA, and DGEBA with MHHPA (catalyzed by 1-MI) is shown in FIG. 4B; the ESA and E4HBA-based epoxy resins exhibited comparable T_{g}'s (138 and 140° C., respectively).

TABLE 2
Glass Transition Temperatures (T_{g}, ° C.) of Epoxy Resins Derived
from Phenolic Acids Using Various Curing Agents^{a}

| Epoxy | | | | | | |
|---|---|---|---|---|---|---|
| Monomer | TETA | DETA | MXDA | IPDA | MHHPA^{b} | NMA^{c} |
| DGEBA | 118 | 137 | 119 | 156 | 155 | 99 |
| ESA (E4HBA) | 81 | 86 | 90 | 112 | 138 (140) | 96 |

^{a}samples were cured using in situ DSC dynamic temperature scan from 40 to 200° C. at a rate of 10° C./min.
^{b}catalyzed by 3 phr 1-MI
^{c}catalyzed by 3 phr Ancamine K54

C. Optimization of Curing Protocol for Anhydride-Cured Epoxidized Phenolic Acids

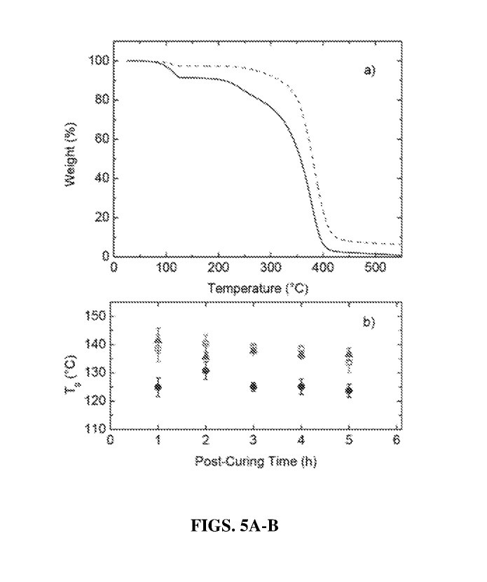

The epoxy resins were cured through a two-stage process in which a lower temperature stage was first employed to cure the resin without significant loss of monomer, and a second, higher temperature stage was then used to achieve high conversion of monomer. The potential evaporation of monomer was monitored with TGA during the first (lower temperature) curing stage (FIG. 5A). The onset monomer evaporation temperatures were observed to be 90.1 and 96.5° C. for the ESA-based and E4HBA-based epoxy resins, respectively. To avoid significant monomer evaporation, 70° C. was chosen as the temperature of the first step in the curing protocol. The reactant mixture for both ESA-based and E4HBA-based epoxy resins was cured in a convection oven at 70° C. for various time periods until solidification (gelation) was observed visually. The ESA-based and E4HBA-based epoxy resins solidified after 1.5 and 2 h, respectively, at 70° C. The first stage in the curing protocol was therefore specified as 70° C. for 2 h.

To avoid vitrification and achieve high conversion, a curing temperature higher than the T_{g} of the final epoxy networks is required. The second curing stage was therefore selected to occur at 170° C., well above the T_{g}'s observed in the in situ DSC experiments (FIGS. 4A-B and Table 2). The three types of epoxy resins (ESA, E4HBA and DGEBA) were cured at 70° C. in the convection oven, and then were subsequently cured at 170° C. in the convection oven for various time periods ranging from 1-5 h. The T_{g} of each resin was monitored as a function of the second stage (170° C.) curing time (FIG. 5B). The T_{g}'s showed little change after the first hour of curing at 170° C., and therefore 2 h was chosen. The final curing protocol was therefore selected to be: 2 h isothermal curing at 70° C. (first stage), followed by 2 h isothermal curing at 170° C. (second stage). The synthetic scheme for the curing of ESA and E4HBA using MHHPA is shown in Scheme 2.

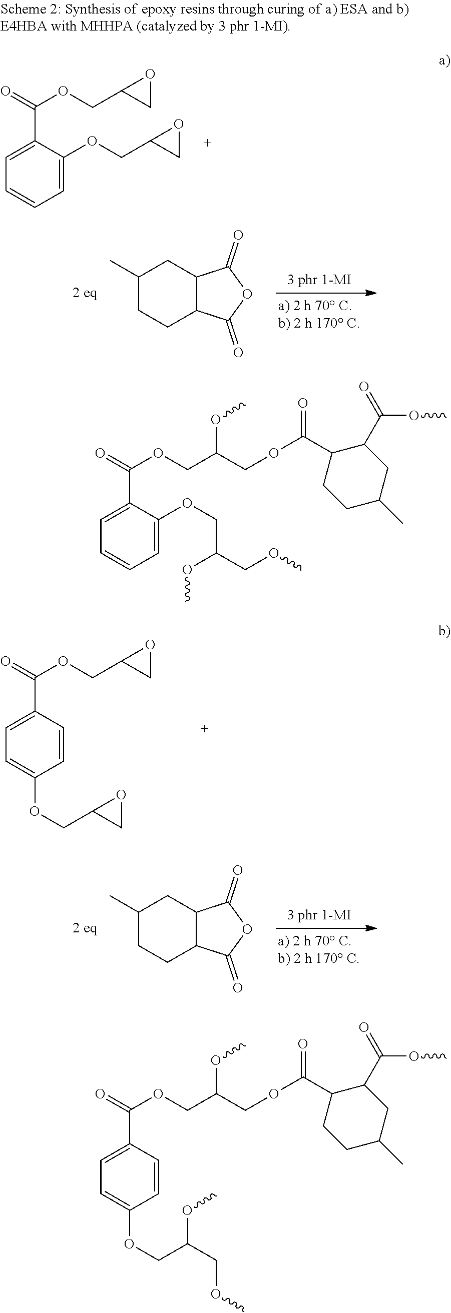

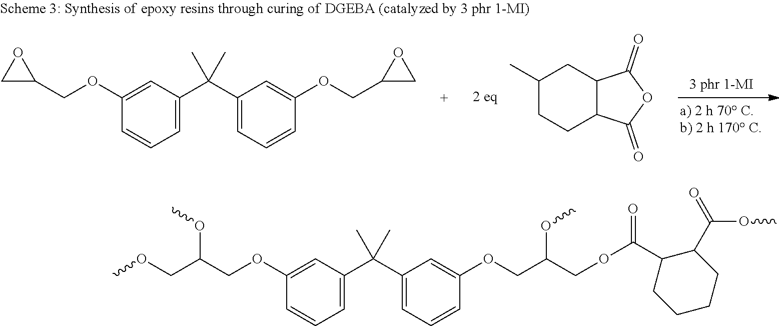

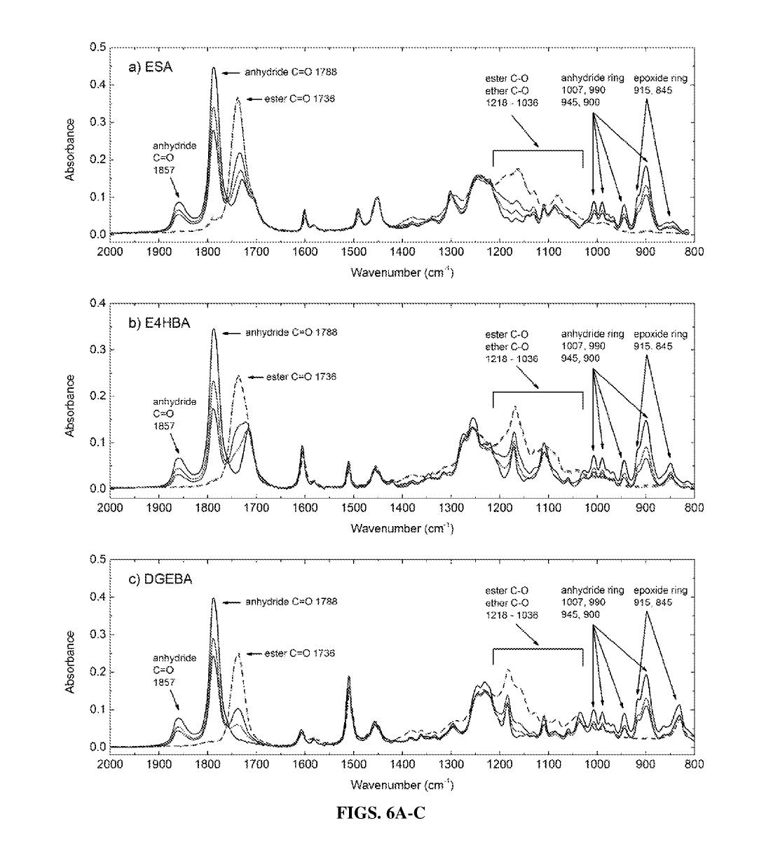

FTIR was used to monitor the curing reactions between MHHPA and ESA, E4HBA, and DGEBA (FIGS. 6A-C). Spectra were obtained following 1 and 2 h of curing at 70° C. (the temperature of the first stage in our curing protocol), which showed a systematic decrease (yet not disappearance) in intensities of peaks associated with anhydride groups (1857 and 1787 cm⁻¹, anhydride C═O stretching (Mertzel and Koenig, 1986); 1007-900 cm⁻¹, cyclic C—CO—O—CO—C stretching (Mertzel and Koenig, 1986; Silverstein and Webster, 1998); as well as a systematic decrease in intensities of peaks associated with epoxide groups (915 cm⁻¹, epoxide C—O stretching and 845 cm⁻¹, epoxide C—O—C stretching (Mertzel and Koenig, 1986; González, et al., 2012; Nikolic, et al., 2010)). Similarly, systematic increases in intensities of peaks associated with formation of the epoxy network were observed (1210-1036 cm⁻¹, ester C—O and ether C—O stretching; 1736 cm⁻¹, ester C═O stretching). Upon heating the sample at 170° C. (the second stage in our curing protocol), the peaks associated with anhydride and epoxide groups drastically reduced after 1 h, showing high conversion of functional groups (in the range of 96-100%, Table 3). Increasing the curing time to 2 and 3 h had little impact on the conversion of functional groups (FIGS. 6A-6C, Table 3).

TABLE 3
Conversion of Epoxy Resins Quantified through FTIR^{a}

| Curing | | | | | | |
|---|---|---|---|---|---|---|
| Time (h)^{b} | | | | | | |
| at 70° C./ | ESA | | E4HBA | | DGEBA | |
| 170° C. | 1857 cm⁻¹ | 1787 cm⁻¹ | 1857 cm⁻¹ | 1787 cm⁻¹ | 1857 cm⁻¹ | 1787 cm⁻¹ |
| 1/0 | 28 ± 3% | 26 ± 2% | 36 ± 3% | 34 ± 2% | 29 ± 2% | 29 ± 1% |
| 2/0 | 44 ± 3% | 40 ± 2% | 55 ± 3% | 53 ± 2% | 43 ± 2% | 40 ± 1% |
| 2/1 | 94 ± 3% | 90 ± 2% | 97 ± 3% | 96 ± 2% | 99.5 ± 0.8% | 97 ± 1% |
| 2/2 | 96 ± 3% | 93 ± 2% | 97 ± 3% | 97 ± 2% | 100^{c} | 97 ± 1% |
| 2/3 | 96 ± 3% | 94 ± 2% | 97 ± 3% | 97 ± 2% | 100^{c} | 97 ± 1% |

^{a}Error bars represent error on analysis of conversion from FTIR peak areas.
^{b}Samples were cured in the convection oven using the MHHPA curing agent (catalyzed with 1-MI). Samples were first cured for the specified time at 70° C., followed by curing at the specified time at 170° C.
^{c}Peak could not be detected.

D. Characterization of Epoxy Resin Mechanical Properties

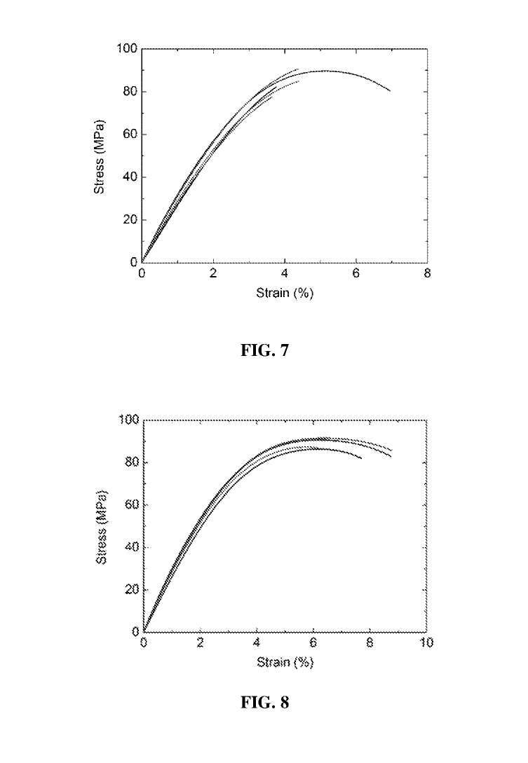

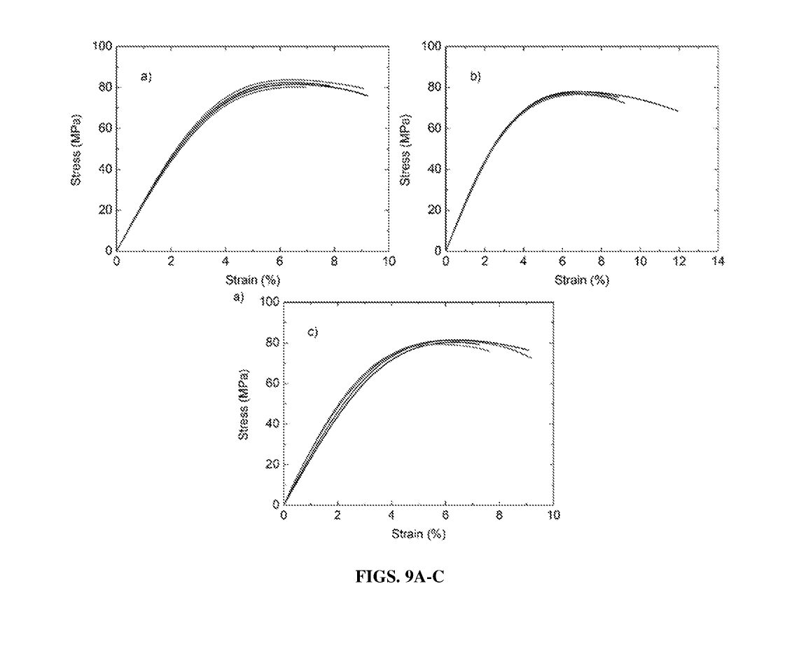

The mechanical properties of the epoxy resins were probed with tensile testing (FIGS. 7A-9C). Tensile experiments were conducted on multiple specimens for each network type; the average values of relevant parameters are shown in Table 4, along with the T_{g}'s of the resins.

TABLE 4
Thermal and Tensile Properties of Epoxy Resins^{a}

| Epoxy | | Tensile strength | % elongation at | Modulus |
|---|---|---|---|---|
| monomer | T_{g} (° C.) | (MPa) | break | (GPa) |
| ESA | 131 ± 3 | 85 ± 6 | 5 ± 1 | 3.0 ± 0.3 |
| E4HBA | 136 ± 5 | 90 ± 2 | 8 ± 1 | 2.9 ± 0.2 |
| DGEBA | 140 ± 3 | 80 ± 2 | 8 ± 2 | 2.5 ± 0.2 |

^{a}Samples were prepared using the following curing protocol: 2 h at 70° C., followed by 2 h at 170° C., with the MHHPA curing agent (catalyzed by 1-MI). The error of the measurement represents the standard deviation of measurements obtained on multiple test specimens.

ESA and E4HBA-based epoxy resins were found to be desirable replacements for DGEBA-based epoxy resins due to their high moduli (around 3 GPa) and tensile strengths (around 85-90 MPa). These attractive properties are likely attributed to the presence of rigid aromatic rings in the network, regardless of whether ESA, E4HBA or DGEBA is used in the resin synthesis. The E4HBA and DGEBA-based epoxy resins also fractured at comparable elongation at break values However, it has been shown that epoxy resins derived from ESA broke at lower elongation compared to E4HBA and DGEBA-based epoxy resins. Without wishing to be bound by any theory, it is believed that differences in the elongation at break originate from differences in the relative placement of functional groups on the epoxy monomers. E4HBA and DGEBA contain epoxide groups at the para positions around the aromatic ring, whereas ESA contains epoxide groups at the ortho position.

E. Analysis of Fracture Mechanisms

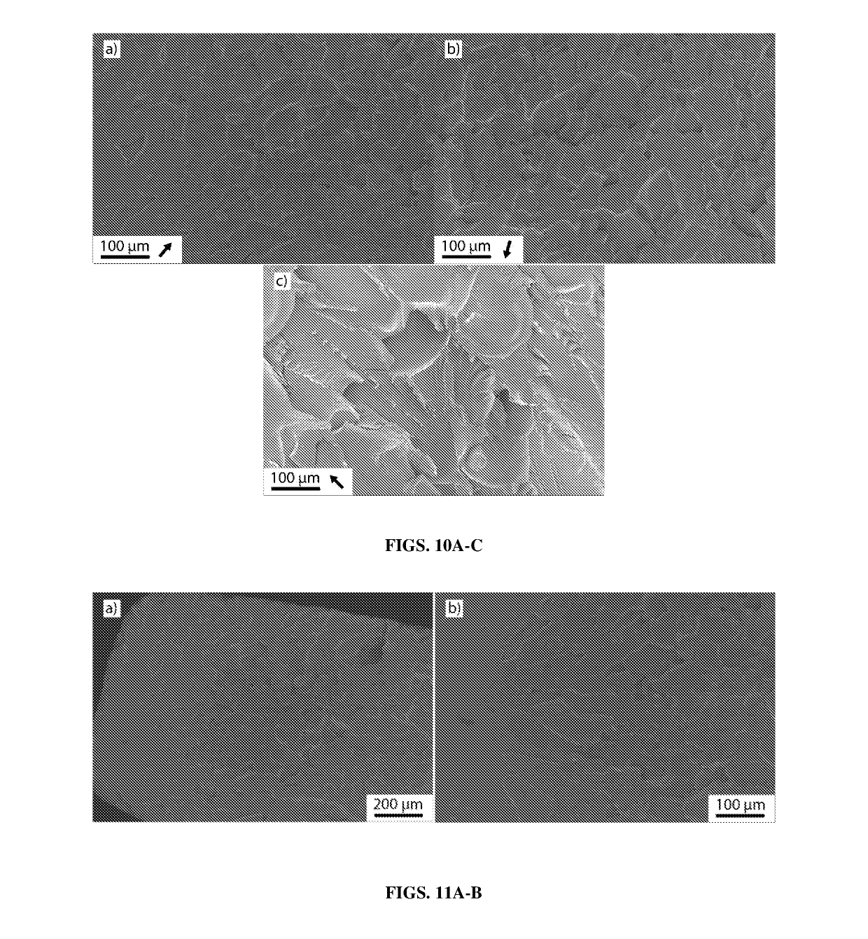

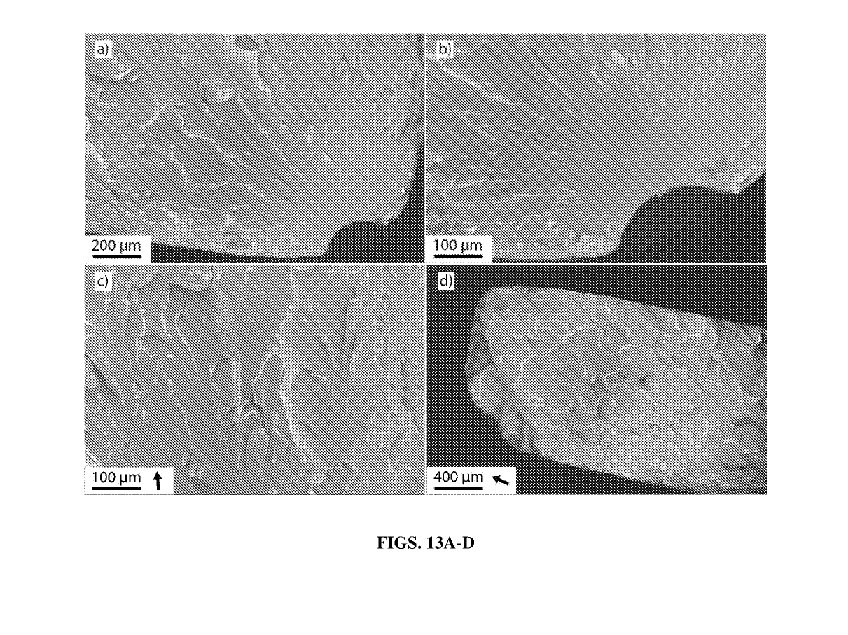

In brittle polymers, cracks generally initiate at a stress concentration point, originating from material inhomogeneity and flaws, and then propagate from a slow crack growth zone (near the crack initiation point) to a rapid crack growth zone (away from crack initiation point). The features present on the fracture surface provide information on the mode of crack growth and deformation mechanisms (Hayes, et al., 2015; Plangsangmas, et al., 1999) Fracture surfaces of the ESA, E4HBA, and DGEBA-based epoxy resin tensile specimens were analyzed with SEM, and the resulting micrographs are shown in FIGS. 10A-13D. In all three specimens, a mirror zone was observed, a region near the crack initiation site which is smooth and featureless, indicative of planar propagation of the crack and observed in brittle materials (Cheng, et al., 2011; Miyagawa, et al., 2005). Moving further away from the crack initiation site, a transitionary mist region was observed, in which the E4HBA and DGEBA-based epoxy resins both exhibited radial striations (Lin and Chen, 2005a; Lin and Chen, 2005b) (FIGS. 12A-13D). Finally, in the region farthest away from the crack initiation site, in which fast crack propagation occurs (the hackle region), parabolic or elliptical features were observed in all three specimens (FIGS. 10A-13D), which result from the intersection of a planar crack front with a secondary propagating front, such as that originating from a craze (Doyle, 1982). The feature shape (parabolic, conical or elliptical) depends on the ratio of the crack velocity to the secondary propagating front velocity (Lin and Chen, 2005a; Lin and Chen, 2005b; Guerra, et al., 2012)

There are noteworthy differences in the behavior of the DGEBA-based epoxy resins compared to the epoxy resins derived from epoxidized phenolic acids. The nucleation center density in the DGEBA-based epoxy resin was significantly less than that of the E4HBA and ESA-based epoxy resins (Table 5). The DGEBA-based epoxy resin also exhibited ridges which were perpendicular to the crack propagation front (FIGS. 10A-C), an indication of increased plastic deformation and energy absorption, (España, et al., 2012; Cheng, et al., 2011) though the tensile toughness of the DGEBA-based epoxy resins was comparable to that of the E4HBA-based epoxy resin.

TABLE 5
Quantification of Features in Tensile Fracture Surfaces^{a}

| Epoxy monomer | Nucleation center density (mm⁻²) |
|---|---|
| ESA | 370 ± 50 |
| E4HBA | 240 ± 70 |
| DGEBA | 21 ± 6 |

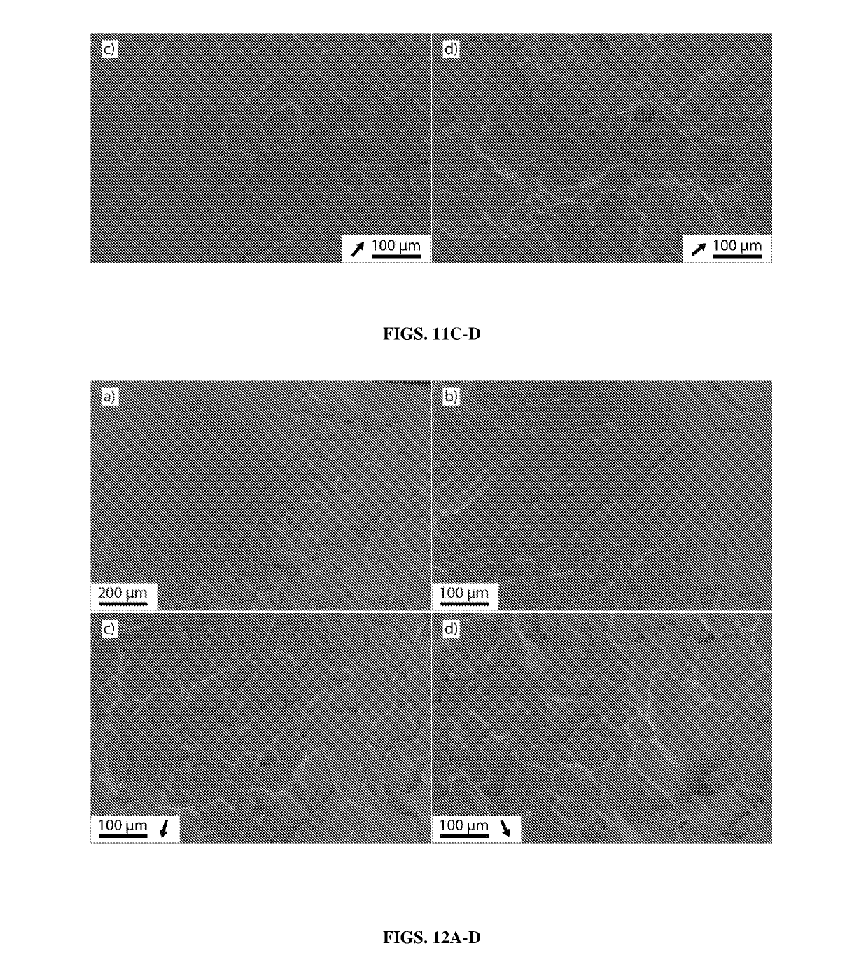

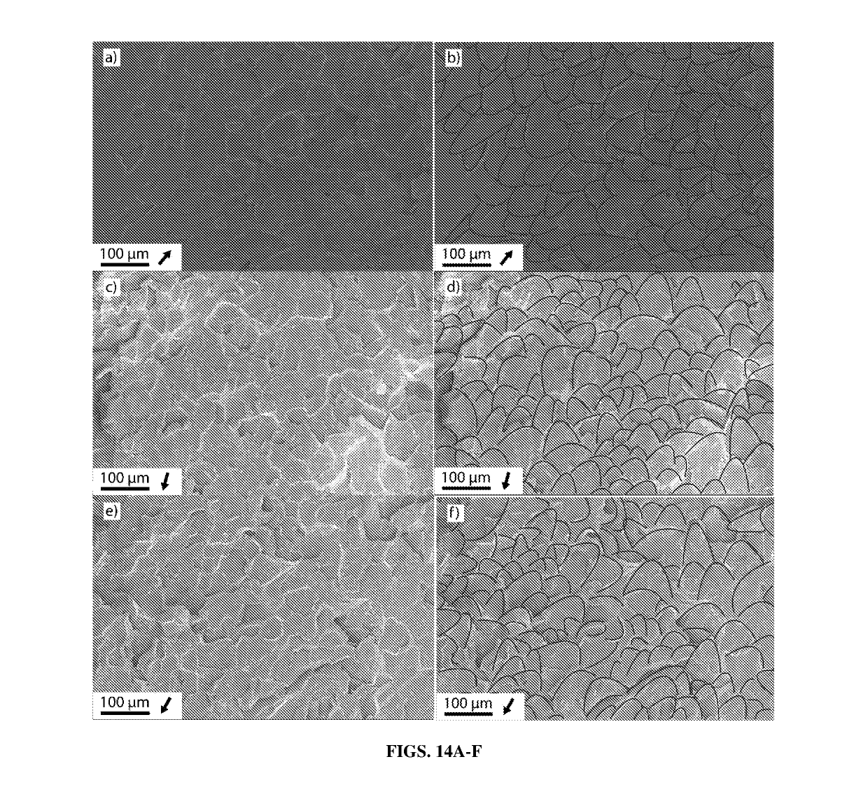

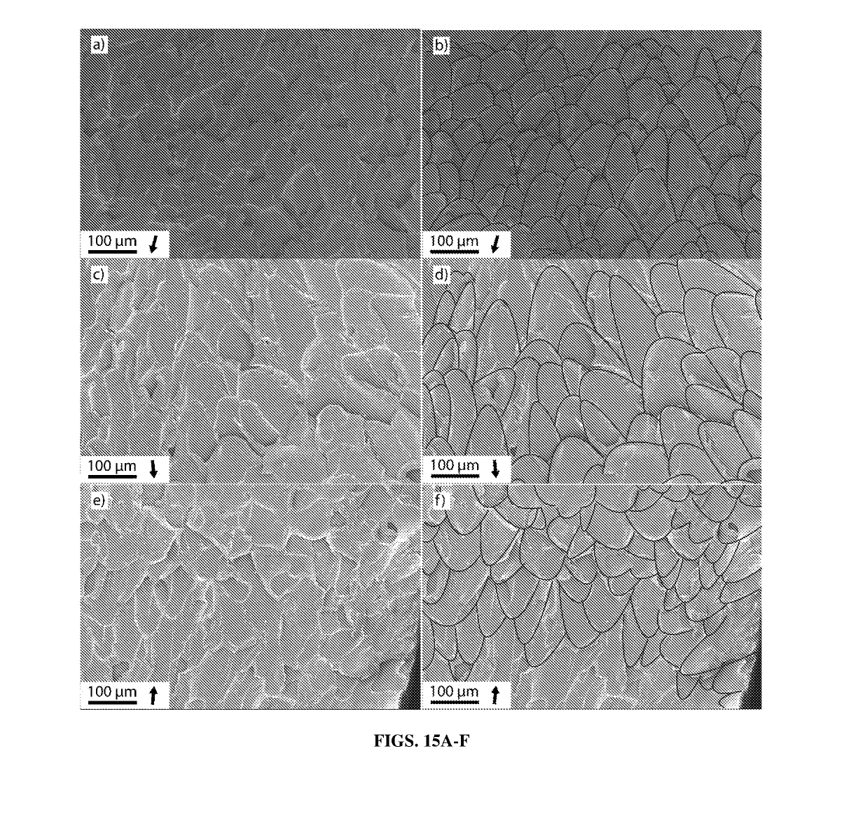

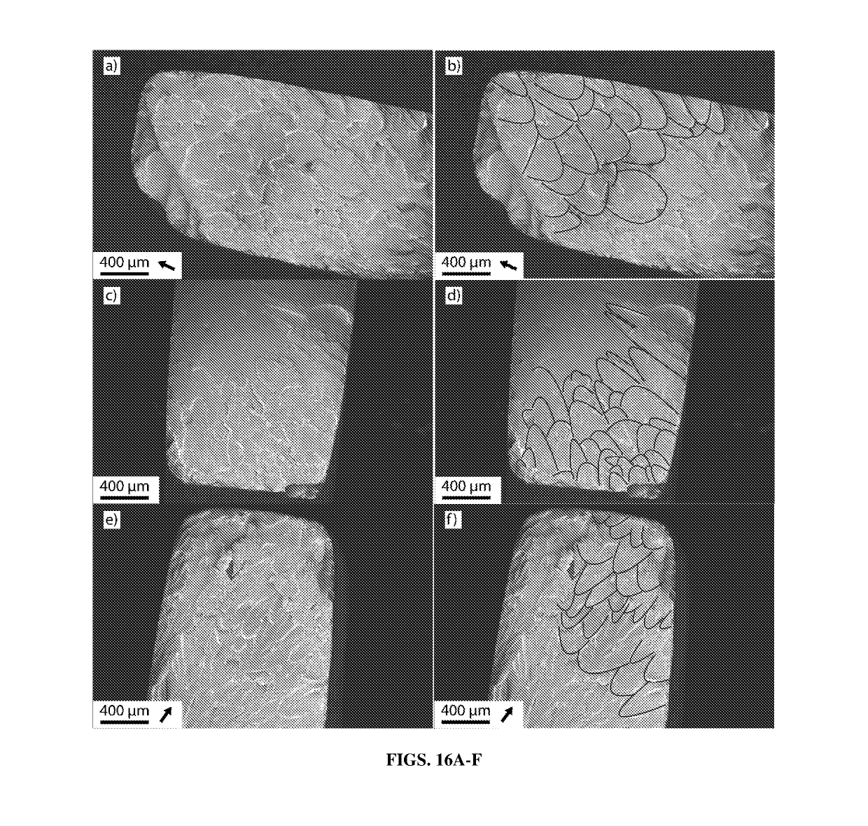

^{a}Quantified in the region of the fracture surface far away from the crack initiation site, on fracture surfaces obtained from three separate test specimens. Additional micrographs are provided in FIGS. 11A-16F.

All of the compounds and methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
Altuna, et al., Journal of Applied Polymer Science 2011, 120 (2), 789-798.
Aouf, et al., European Polymer Journal 2013, 49 (6), 1185-1195.
Busto, et al., Controlling Water Uptake of Sugar Based Epoxy Resins. Ieee: New York, 2011.
Cheng, et al., J. Appl. Polym. Sci. 2011, 119 (6), 3504-3510.
Chrysanthos, et al., Polymer 2011, 52 (16), 3611-3620.
Czub, Macromol. Symp. 2006, 242, 60-64.
Czub, Polym. Adv. Technol. 2009, 20 (3), 194-208.
Doyle, Journal of Materials Science 1982, 17 (3), 760-768.
El Gouri, et al., Polymer Degradation and Stability 2009, 94 (11), 2101-2106.
España, et al., J. Am. Oil Chem. Soc. 2012, 89 (11), 2067-2075.
Espinoza-Perez, et al., Polym. Compos. 2011, 32 (11), 1806-1816.
Feng, et al., Polymers for Advanced Technologies 2011, 22 (1), 139-150.
Feng, et al., Journal of Thermal Analysis and calorimetry 2012, 109 (3), 1267-1275.
Frischinger and Dirlikov, Polymer Communications 1991, 32 (17), 536-537.
Frischinger and Dirlikov, Adv. Chem. Ser. 1993, (233), 451-489.
Gonçalves, et al., Materials Research 2014, 17 (4), 878-887.
González, et al., In Infrared Spectroscopy—Materials Science, Engineering and Technology, Theophile, T., Ed. InTech: Spain, 2012.
Guerra, et al., Proc. Natl. Acad. Sci. USA, 2012, 109 (2), 390-394.
Gupta, et al., Polymer Engineering & Science 2011, 51 (6), 1087-1091.
Hayes, et al., 4—Fractography Basics. In Fractography in Failure Analysis of Polymers, William Andrew Publishing: Oxford, 2015; pp 48-92.
Haymana, et al., MRS Bulletin 2008, 33 (0.4), 343-353.
Jin and Park, Polymer International 2008a, 57 (4), 577-583.
Jin and Park, Mater. Sci. Eng. A-Struct. Mater. Prop. Microstruct. Process. 2008b, 478 (1-2), 402-405.
Lin and Chen, Materials Letters 2005a, 59 (29-30), 3831-3836.
Lin and Chen, Polymer 2005b, 46 (25), 11994-12003.
Liu, et al., Journal of Applied Polymer Science 2004, 93 (1), 356-363.
Liu, et al., Express Polym. Lett. 2012, 6 (4), 293-298.
Lukaszczyk, et al., European Polymer Journal 2011, 47 (8), 1601-1606.
Manach, et al., The American Journal of Clinical Nutrition 2004, 79 (5), 727-747.
Mertzel and Koenig, In Epoxy Resins and Composites II, Dušek, K., Ed. Springer Berlin Heidelberg: 1986; pp 73-112.
Miyagawa, et al., Polym. Eng. Sci. 2005, 45 (4), 487-495.
Mustata, et al., Compos. Pt. B—Eng. 2011, 42 (7), 1803-1812.
Naczk and Shahidi, Journal of Pharmaceutical and Biomedical Analysis 2006, 41 (5), 1523-1542.
Nelson, et al., Polymer International 2012, 61 (10), 1485-1491.
Nikolic, et al., Sensors 2010, 10 (1), 684-96.
Park, et al., Macromol. Chem. Phys. 2004a, 205 (15), 2048-2054.
Park, et al., Mater. Sci. Eng. A—Struct. Mater. Prop. Microstruct. Process. 2004b, 374 (1-2), 109-114.
Pham and Marks, Epoxy Resins. In Encyclopedia of Polymer Science and Technology, John Wiley & Sons, Inc.: 2002.
Plangsangmas, et al., Journal of Applied Polymer Science 1999, 72 (2), 257-268.
Raquez, et al., Progress in Polymer Science 2010, 35 (4), 487-509.
Ritchie, Nature materials 2011, 10 (11), 817-22.
Russell, et al., Food Chemistry 2009, 115 (1), 100-104.
Samper, et al., J. Am. Oil Chem. Soc. 2012, 89 (8), 1521-1528.
Sarwono, et al., J. Polym. Environ. 2012, 20 (2), 540-549.
Schieber, et al., Trends in Food Science & Technology 2001, 12 (11), 401-413.
Silverstein and Webster, Spectrometric Identification of Organic Compounds. 6th ed.; John Wiley & Sons, Inc.: New York, 1998.
Simionescu, et al., Composites Science and Technology 1993, 48, 317-323.
Sobrinho, et al., Polymer Composites 2012, 33 (2), 295-305.
Sun, et al., Journal of Applied Polymer Science 2007, 105 (4), 2332-2338.
Supanchaiyamat, et al., Green Chemistry 2012, 14 (6), 1759.
Tan, et al., Polymer—Plastics Technology and Engineering 2010, 49 (15), 1581-1590.
Tan, et al. , J. Am. Oil Chem. Soc. 2011, 88 (7), 915-923.
van Beilen and Poirier, Plant Journal 2008, 54 (4), 684-701.
Vandenberg, et al., Endocrine reviews 2009, 30 (1), 75-95.
Varma and Chavan, CELLULOSE 1994, 1, 215-219.
Yang, et al., Green Materials 2013, 1 (2), 125-134.
Yang, et al., Macromolecules 2015, 48 (23), 8418-8427.
Yang, et al., Polymer 2015, 77, 129-142.
Zhang; and Xu, Polymer Engineering & Science 1989, 29, 1142-1146.
Zhao and Luo, Materials Science and Engineering: A 2008, 483-484, 313-315.

1. A resin comprising:
(A) a naturally occurring aromatic compound wherein the aromatic compound has been modified to contain at least one epoxidized hydroxy group and at least one epoxidized carboxylic acid group; and
(B) a curing agent selected from an anhydride, an acid, an alcohol, a thiol, a phenol, or an amine;
provided that the aromatic compound is not an epoxidized version of gallic acid.

2. The resin of claim 1, wherein the aromatic compound contains one epoxidized hydroxy group.

3. The resin of claim 1, wherein the aromatic compound contains one epoxidized carboxylic acid group.

4. The resin of claim 1, wherein the aromatic compound contains one epoxidized hydroxy group and one epoxidized carboxylic acid group.

5. The resin of claim 1, wherein the aromatic compound is further defined as: 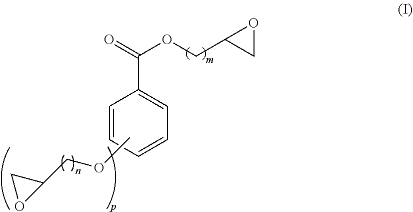
wherein:
n and m are each independently 0, 1, 2, 3, or 4; and
p is 1, 2, or 3.

6-7. (canceled)

8. The resin according to claim 1, wherein the curing agent is an anhydride.

9-13. (canceled)

14. The resin according to claim 1, wherein the curing agent is an amine.

15-19. (canceled)

20. The resin according to claim 1, wherein the resin has a glass transition temperature from about 75° C. to about 200° C.

21-22. (canceled)

23. The resin according to claim 1, wherein the resin has a tensile strength of greater than 50 MPa.

24. (canceled)

25. The resin according to claim 1, wherein the resin has a modulus of greater than 1.0 GPa.

26. (canceled)

27. The resin according to claim 1, wherein the resin had an increased nucleation center density relative to DGEBA.

28-29. (canceled)

30. A method of preparing a resin comprising:
(A) admixing a naturally occurring aromatic compound with a curing agent in the presence of a catalyst and heating to a first temperature for a first time period to form a first reaction mixture; and
(B) heating the first reaction mixture to a second temperature for a second time period to obtain a resin;
provided that the aromatic compound is not an epoxidized gallic acid.

31. The method of claim 30, wherein the aromatic compound contains one epoxidized hydroxy group.

32. The method of claim 30, wherein the aromatic compound contains one epoxidized carboxylic acid group.

33. The method of claim 30, wherein the aromatic compound contains one epoxidized hydroxy group and one epoxidized carboxylic acid group.

34. The method of claim 30, wherein the aromatic compound is further defined as: 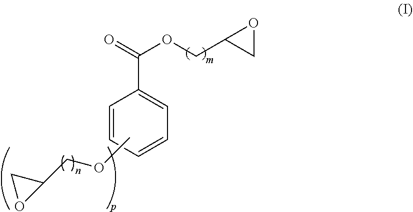
wherein:
n and m are each independently 0, 1, 2, 3, or 4; and
p is 1, 2, or 3.

35-36. (canceled)

37. The method according to claim 30, wherein the curing agent is an anhydride, an acid, an alcohol, a thiol, a phenol, or an amine.

38. The method according to claim 30, wherein the curing agent is an anhydride.

39-43. (canceled)

44. The method according to claim 30, wherein the curing agent is an amine.

45-49. (canceled)

50. The method according to claim 30, wherein the catalyst is a Lewis base.

51-55. (canceled)

56. The method according to claim 30, wherein the first temperature is from about 50° C. to about 300° C.

57-58. (canceled)

59. The method according to claim 30, wherein the first time period is from about 10 minutes to about 12 hours.

60-61. (canceled)

62. The method according to claim 30, wherein the second temperature is from about 50° C. to about 300° C.

63-64. (canceled)

65. The method according to claim 30, wherein the second time period is from about 10 minutes to about 12 hours.

66-67. (canceled)

68. The method according to claim 30, wherein the mole ratio of the curing agent to the aromatic compound is from about 0.5 to about 5.

69-70. (canceled)

71. The method according to claim 30, wherein the mole ratio of the curing agent is equal to the number of epoxide groups on the aromatic compound.

72. The method according to claim 30, wherein the amount of catalyst present in the method is from about 100 parts per thousand relative to the resin to about 100 parts per hundred.

73-74. (canceled)

75. The method according to claim 30, wherein the resin has a glass transition temperature from about 75° C. to about 200° C.

76-77. (canceled)

78. The method according to claim 30, wherein the method produces a resin with a tensile strength of greater than 50 MPa.

79. (canceled)

80. The method according to claim 30, wherein the method produces a resin with a modulus of greater than 1.0 GPa.

81. (canceled)

82. The method according to claim 30, wherein the method produces a resin with an increased nucleation center density relative to DGEBA.

83-84. (canceled)

85. An article of manufacture prepared using the resin described in claim 1.

86-88. (canceled)
